(19) United States
(12) Patent Application Publication
(10) Pub. No.: US 2007/0239615 A1
(43) Pub. Date: Oct. 11, 2007

(54) Personal Information Management Device, Distributed Key Storage Device, and Personal Information Management System

(76) Inventors: Natsume Matsuzaki, Osaka (JP); Kaoru Yokota, Hyogo (JP); Masao Nonaka, Osaka (JP); Mitsuhiro Inoue, Osaka (JP); Tohru Nakahara, Osaka (JP); Akio Higashi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/578,787

(22) PCT Filed: Apr. 22, 2005
(86) PCT No.: PCT/JP05/07695

§ 371 Date: Oct. 18, 2006

(30) Foreign Application Priority Data
Apr. 23, 2004 (JP) 2004-127806

(51) Int. Cl. G06Q 99/00

(52) U.S. Cl. 705/55

(57) ABSTRACT

A personal information management device aims to save troubles of inputting passwords and deleting personal information, to prevent others from viewing the personal information, and to maintain confidentiality of the personal information even when a mobile device is lost. Personal information storage unit 201 holds encrypted personal information, key distribution unit 204 distributes a decryption key used for decrypting the encrypted personal information into a first and a second distributed keys based on a secret sharing scheme, distributed key storage unit 205 stores thereon the first distributed key, stores the second distributed key on home device 30, and deletes the decryption key. Upon decryption, link judgment unit 210 judges link establishment. Key recovery unit 207 acquires the second distributed key from home device 30, and recovers the decryption key using the first and the second distributed keys. Decryption unit 208 decrypts the encrypted personal information using the decryption key.

### TECHNICAL FIELD

The present invention relates to a personal information management device that manages personal information, and specifically to protection of the personal information in case of loss of the personal information management device.

### BACKGROUND ART

In recent years, mobile devices equipped with a camera function such as PDAs (Personal Digital Assistant) and mobile phones have become prevalent. Users of such mobile devices often carry personal information such as a taken photograph stored on the mobile devices. This increases importance of a measure for preventing a third person from viewing the personal information in case of loss of the mobile devices.

A first conventional example of such measure in case of loss of a mobile device is an art of locking the mobile device using a password. A third person cannot unlock the locked mobile device because he does not know the password, thereby preventing the third person from retrieving the personal information.

Also, a second conventional example of such measure is an art of moving personal information stored on a mobile device to a server, and deleting the personal information from the mobile device.

Furthermore, a third conventional example of such measure is an art of invalidating in a mobile phone, which is disclosed in Japanese Patent Application Publication No. H11-177682. Here, a system of invalidating a SIM (Subscriber Identification Module) card inserted into a wireless communication device such as a mobile phone is disclosed. A memory of the SIM card stores personal data of a user in addition to an ID code, and further stores a specific invalidating code. When the SIM card is lost, the user transmits the invalidating code from another mobile phone to the SIM card. The SIM card authorizes the invalidating code, and then locks the personal data stored on the memory of the SIM card to make the data unavailable. This prevents unauthorized use by others and leakage of the personal data.

Patent Document Japanese Patent Application Publication No. 2002-91301

### DISCLOSURE OF THE INVENTION

### The Problems the Invention is Going to Solve

However, the first conventional example has a problem. Since a human-memorizable password digit number is at most 10, a password brute-force attack reveals the password. Also, if the user forgets the password, the mobile device cannot be unlocked.

Also, the second conventional example has a problem. Suppose the user frequently uses the personal information inside a home of the user. Each time going out of the home, the user needs to transfer the personal information to the server and delete the personal information from the mobile device, thereby causing inconvenience.

Furthermore, the third conventional example has a problem. Until the user notices loss of the mobile phone, the data keeps unlocked, thereby a possibility lies in leakage of the data.

In view of the above problems, the present invention aims to provide a personal information management device, a distributed key storage device, a personal information management system, a personal information management method, a computer program, a storage medium, and an integrated circuit that can save a user of a mobile device troubles of inputting passwords or deleting personal information, prevent a person other than the user from viewing the personal information, and maintain confidentiality of the personal information in case of loss of the mobile device.

### MEANS TO SOLVE THE PROBLEMS

In order to solve the above problems, the present invention is a personal information management device that manages personal information, including: an information storage unit storing the personal information in encrypted form; a distributed key storage unit storing a first distributed key, where the first distributed key and a second distributed key are distributed from a decryption key based on a secret sharing scheme; a link judgment unit operable to judge whether communication is possible with a distributed key storage device storing the second distributed key; an acquisition unit operable to, when the communication is possible, acquire the second distributed key from the distributed key storage device; a decryption key recovering unit operable to recover the decryption key using the first and the second distributed keys based on the secret sharing scheme; and a decryption unit operable to decrypt the encrypted personal information using the recovered decryption key.

### EFFECT OF THE INVENTION

With the structure described above, the personal information management device of the present invention can restrict recovering personal information based on the secret sharing scheme to when the personal information management device can communicate with the distributed key storage device.

Therefore, when the distributed key storage device is disposed in a specified position such as inside a home of a user of the personal information management device, and when the personal information management device performs wireless communication with the distributed key storage device only inside the home, the personal information management device can restrict recovering the personal information to inside the home. Also, when the personal information management device performs wireless communication with the distributed key storage device attached to a belonging of the user within a communication range of only one meter, the personal information management device can restrict recovering the personal information to when the user carries the belonging so that the personal information management device and the belonging are within a range of only one meter.

The link judgment unit may include: a link request unit operable to transmit a link request to the distributed key storage device within a predetermined communication range; a link response receiving unit operable to receive a response to the link request from the distributed key storage device; and a determination unit operable to, when the response is received, determine that the communication is possible with the distributed key storage device.

According to this structure, the personal information management device can restrict recovering personal information based on the secret sharing scheme to when the distributed key storage device receives the link request and the link judgment unit receives the link response that is a response to the link request.

The distributed key storage device may be disposed in a specified position, and transmit a packet to the personal information management device within a predetermined communication range at a predetermined time interval, and the link judgment unit may include: a packet receiving unit operable to receive the packet; and a determination unit operable to, when the packet is received, determine that the communication is possible with the distributed key storage device.

According to this structure, the personal information management device can restrict recovering personal information based on the secret sharing scheme to when the link judgment unit receives the packet.

The distributed key storage device may hold judgment information for the link judgment unit to judge whether the communication is possible, and the link judgment unit may include: a reading unit operable to read the judgment information held in the distributed key storage device within a predetermined communication range; and a determination unit operable to, when the judgment information is read, determine that the communication is possible.

According to this structure, the personal information management device can restrict recovering personal information based on the secret sharing scheme to when the link judgment unit can read the judgment information.

The distributed key storage device may be an IC tag attached to a belonging of a user of the personal information management device, and the reading unit may read the judgment information held in the IC tag within a wireless access range. According to this structure, the personal information management device can restrict recovering personal information based on the secret sharing scheme to when the personal information management device is within the wireless access range of the IC tag.

The link judgment unit may include: an address storage unit storing an IP address of the personal information management device; an address acquisition unit operable to acquire an IP address of the distributed key storage device; an address judgment unit operable to judge whether the IP address of the personal information management device and the IP address of the distributed key storage device belong to a same subnetwork; and a determination unit operable to, when the judgment is affirmative, determine that the communication is possible with the distributed key storage device.

According to this structure, the personal information management device can restrict recovering personal information based on the secret sharing scheme to when the personal information management device and the distributed key storage device belong to the same subnetwork.

The link judgment unit, after judging that the communication is possible with the distributed key storage device, may further periodically judge whether the communication is possible, and the personal information management device further may include a deletion unit operable to, when the communication is impossible, delete the decryption key recovered by the decryption key recovering unit and the personal information decrypted by the decryption unit.

According to this structure, the personal information management device can prevent viewing personal information when the personal information management device cannot communicate with the distributed key storage device.

This enables the personal information management device to prevent an unauthorized situation, where the personal information is viewed despite that the personal information management device cannot communicate with the distributed key storage device.

The personal information management device may further include: a distributed key generation unit operable to distribute the decryption key into the first and the second distributed keys based on the secret sharing scheme, and delete the decryption key; a distributed key transmission unit operable to transmit the second distributed key to the distributed key storage device; and a writing unit operable to store the first distributed key on the distributed key storage unit.

According to this structure, the personal information management device can recover a decryption key.

The personal information management device may further include: a distributed key receiving unit operable to receive the first distributed key; and a writing unit operable to store the received first distributed key on the distributed key storage unit.

According to this structure, the personal information management device can acquire a distributed key from an external device.

This enables the personal information management device to have a structure separating a device for generating a distributed key from the decryption key and a device for storing the distributed key.

The information storage unit may further store encrypted additional personal information, the personal information management device may further include: an additional distributed key storage unit storing one of n additional distributed keys distributed from an additional decryption key based on a (k,n) threshold secret sharing scheme; an additional link judgment unit operable to judge whether each communication is possible with (n-1) additional distributed key storage devices each storing any one of (n-1) additional distributed keys that are mutually different other than the one additional distributed key; an additional acquisition unit operable to, when the communication is possible with no less than (k-1) additional distributed key storage devices, acquire an additional distributed key from each of the (k-1) additional distributed key storage devices; an additional decryption key recovering unit operable to recover the additional decryption key using the (k-1) additional distributed keys and the one additional distributed key based on the (k,n) threshold secret sharing scheme; and an additional decryption unit operable to decrypt the encrypted additional personal information using the recovered additional decryption key.

According to this structure, the personal information management device can restrict recovering additional personal information based on the (k,n) threshold secret sharing scheme to when the personal information management device can communicate with no less than (k-1) distributed key storage devices.

The present invention is a distributed key storage device manages a distributed key generated based on a secret sharing scheme, including: a distributed key storage unit storing a first distributed key, where the first distributed key and a second distributed key are distributed from a decryption key used for decrypting encrypted personal information based on a secret sharing scheme; a communication unit operable to communicate, such that a personal information management device storing the encrypted personal information judges whether communication is possible; and a transmission unit operable to transmit the first distributed key to the personal information management device.

According to this structure, recovering personal information by the personal information management device based on the secret sharing scheme can be restricted to when the personal information management device can communicate with the distributed key storage device.

The communication unit may include: a request receiving unit operable to receive a link request from the personal information management device; and a response transmission unit operable to transmit a response to the link request.

According to this structure, recovering personal information by the personal information management device based on the secret sharing scheme can be restricted to when the distributed key storage device receives the link request and the link judgment unit receives the response to the link request.

The distributed key storage device may be disposed in a specified position, and the communication unit may transmit a packet to the personal information management device within a predetermined communication range at a predetermined time interval.

According to this structure, recovering personal information by the personal information management device based on the secret sharing scheme can be restricted to when the personal information management device receives the packet transmitted by the communication unit.

The distributed key storage device may hold judgment information for the communication unit to judge whether the communication is possible, wherein the communication unit transmits the judgment information to the personal information management device within a predetermined communication range.

According to this structure, recovering personal information by the personal information management device based on the secret sharing scheme can be restricted to when the personal information management device can read the judgment information.

The distributed key storage device may be an IC tag attached to a belonging of a user of the personal information management device, and the communication unit may transmit the judgment information to the personal information management device within a wireless access range.

According to this structure, the personal information management device can restrict recovering personal information based on the secret sharing scheme to when the personal information management device is within the wireless access range of the IC tag.

The present invention is a personal information management system including a personal information management device that manages personal information and a distributed key storage device, the distributed key storage device including: a first distributed key storage unit storing a first distributed key, where the first distributed key and a second distributed key are distributed from a decryption key based on a secret sharing scheme; a first link judgment unit operable to judge whether communication is possible with the personal information management device; and a transmission unit operable to, when the communication is possible with the personal information management device, transfer the first distributed key to the personal information management device, the personal information management device including: a information storage unit storing the encrypted personal information; a second distributed key storage unit storing the second distributed key; a second link judgment unit operable to judge whether communication is possible with the distributed key storage device; an acquisition unit operable to, when the communication is possible with the distributed key storage device, acquire the first distributed key from the distributed key storage device; a decryption key recovering unit operable to recover the decryption key using the first and the second distributed keys based on the secret sharing scheme; and a decryption unit operable to decrypt the encrypted personal information using the recovered decryption key.

The present invention is a personal information management method used in a personal information management device storing encrypted personal information and a first distributed key, where the first distributed key and a second distributed key are distributed from a decryption key based on a secret sharing scheme, the personal information management method including steps of: judging a link whether communication is possible with a distributed key storage device storing the second distributed key; acquiring, when the communication is possible, the second distributed key from the distributed key storage unit; recovering the decryption key using the first and the second distributed keys based on the secret sharing scheme; and decrypting the encrypted personal information using the recovered decryption key.

The present invention is a computer program used in a personal information management device storing encrypted personal information and a first distributed key, where the first distributed key and a second distributed key are distributed from a decryption key based on a secret sharing scheme, the computer program including steps of: judging a link whether communication is possible with a distributed key storage device storing the second distributed key; acquiring, when the communication is possible, the second distributed key from the distributed key storage unit; recovering the decryption key using the first and the second distributed keys based on the secret sharing scheme; and decrypting the encrypted personal information using the recovered decryption key.

The present invention is a storage medium storing the computer program.

According to this structure, recovering personal information based on the secret sharing scheme can be restricted to when the personal information management device can communicate with the distributed key storage device.

Therefore, when the distributed key storage device is disposed in a specified position such as inside a home of a user of the personal information management device, and when the personal information management device performs wireless communication with the distributed key storage device only inside the home, the personal information management device can restrict recovering the personal information to inside the home. Also, when the personal information management device performs wireless communication with the distributed key storage device attached to a belonging of the user within a communication range of only one meter, the personal information management device can restrict recovering the personal information to when the user carries the belonging so that the personal information management device and the belonging are within a range of only one meter.

The present invention is an integrated circuit that manages personal information, including: an information storage unit storing the personal information in encrypted form; a distributed key storage unit storing a first distributed key, where the first distributed key and a second distributed key are distributed from a decryption key based on a secret sharing scheme; a link judgment unit operable to judge whether communication is possible with a distributed key storage device storing the second distributed key; an acquisition unit operable to, when the communication is possible, acquire the second distributed key from the distributed key storage device; a decryption key recovering unit operable to recover the decryption key using the first and the second distributed keys based on the secret sharing scheme; and a decryption unit operable to decrypt the encrypted personal information using the recovered decryption key.

According to this structure, recovering personal information based on the secret sharing scheme can be restricted to when the integrated circuit can communicate with the distributed key storage device.

Therefore, when the distributed key storage device is disposed in a specified position such as inside a home of a user of the integrated circuit, and when the integrated circuit performs wireless communication with the distributed key storage device only inside the home, the personal information management device can restrict recovering the personal information to inside the home. Also, when the integrated circuit performs wireless communication with the distributed key storage device attached to a belonging of the user within a communication range of only one meter, the integrated circuit can restrict recovering the personal information to when the user carries the belonging so that the integrated circuit and the belonging are within a range of only one meter.

### BRIEF DESCRIPTION OF THE DRAWINGS

FIG. 1 shows an overall structure of a personal information management system according to the present invention;

FIG. 2 is a block diagram showing a mobile device;

FIG. 3 shows an example of encryption control information stored on an encryption control information storage unit;

FIG. 4 shows an example of a personal information file stored on a personal information storage unit;

FIG. 5 shows an example of key identification information and a distributed key stored on a distributed key storage unit;

FIG. 6 is a block diagram showing a structure of a home device;

FIG. 7 is a block diagram showing a structure of an IC tag;

FIG. 8 shows an example of personal information stored on the personal information storage unit;

FIG. 9 is a flowchart showing encryption processing using the personal information management system;

FIG. 10 is a flowchart showing decryption processing using the personal information management system;

FIG. 11 is a block diagram showing a structure of a personal information management system according to a modification example of an embodiment;

FIG. 12 is a block diagram showing a structure of a personal information management system according to a modification example of the embodiment; and

FIG. 13 shows a backup concept of a distributed key and encrypted personal information stored on the mobile device.

### DESCRIPTION OF CHARACTERS

1: personal information management system
20: mobile device
30: home device
40: IC tag
41: wireless communication unit
42: tag ID storage unit
43: distributed key storage unit
50: IC tag
51: wireless communication unit
52: tag ID storage unit
53: distributed key storage unit
60: IC Tag
61: wireless communication unit
62: tag ID storage unit
63: distributed key storage unit
201: personal information storage unit
202: key generation unit
203: encryption unit
204: key distribution unit
205: distributed key storage unit
206: transmission/reception unit
207: key recovery unit
208: decryption unit
209: key deletion control unit
210: link judgment unit
211: device information storage unit
212: IC tag communication unit
213: personal information acquisition unit
214: encryption control information storage unit
215: user input acquisition unit
216: control unit
217: display unit
301: transmission/reception unit
302: distributed key storage unit
303: link judgment unit
304: device information storage unit

### BEST MODE FOR CARRYING OUT THE INVENTION

<Outline>

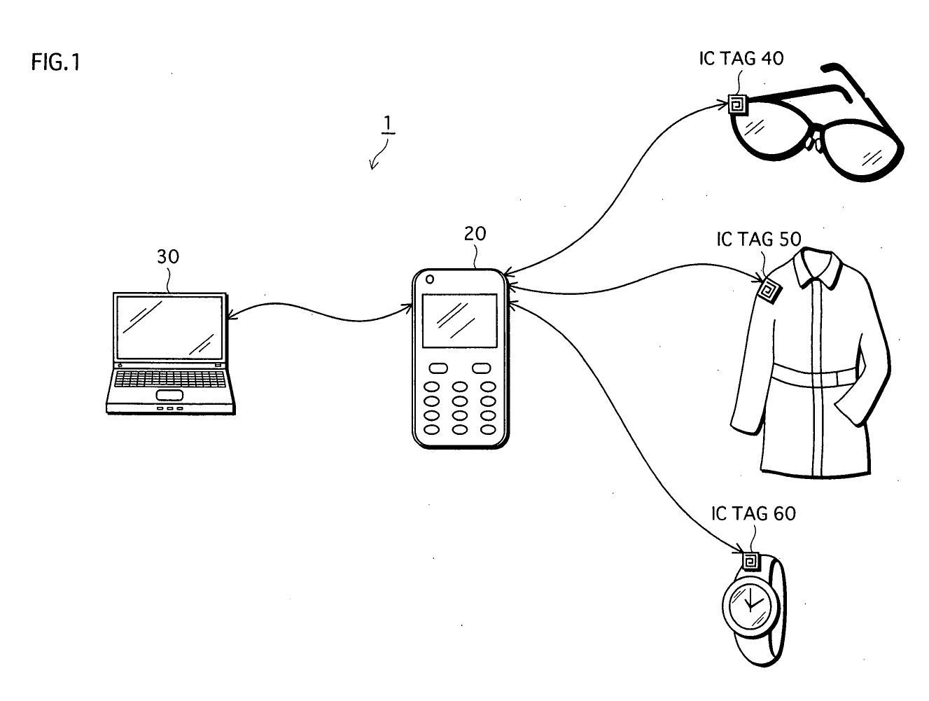

A Personal information management system 1 according to an embodiment restricts viewing of personal information stored on a mobile device to inside a home of a user of the mobile device, and to the user of the mobile device. As shown in FIG. 1, the personal information management system 1 is composed of a mobile device 20, a home device 30, an IC tag 40 attached to glasses, an IC tag 50 attached to a coat, and an IC tag 60 attached to a watch.

The home device 30 is a personal computer disposed inside the home where a wireless LAN (Local Area Network) is laid.

The mobile device 20 is a PDA having a digital camera, connects with the home device 30 via the wireless LAN, and communicates with the IC tags 40, 50, and 60 respectively via a wireless of a system different from the wireless LAN. Also, the home device 20 stores personal information of the user of the mobile device 20, such as a schedule, an address book including telephone numbers and electronic mail addresses for communication, and an image photographed by the user using the digital camera.

In order to restrict viewing of the personal information to inside the home of the user, the mobile device 20 encrypts the personal information using an encryption key, distributes the encryption key to generate two distributed keys, holds therein one of the two distributed keys, and holds the other distributed key in the home device 30. Note that the encryption key is identical with a decryption key.

When the mobile device 20 can acquire the two distributed keys held in the mobile device 20 and the home device 30, that is, when the mobile device 20 and the home device 30 are inside the home, the mobile device 20 recovers the decryption key identical with the encryption key using the two distributed keys, and decrypts the encrypted personal information using the decryption key.

Also, in order to restrict viewing of the personal information to only the user, the mobile device 20 encrypts the personal information using an encryption key, distributes the encryption key to generate four distributed keys, holds therein one of the four distributed keys, and holds the other three distributed keys in the IC tags 40, 50, and 60 respectively, the IC tags 40, 50, and 60 being attached to the glasses, the coat, and the watch that are belongings of the user, respectively.

When the mobile device 20 can acquire, for example, three of the four distributed keys including the distributed key held therein, the mobile device 20 recovers the decryption key using the three distributed keys, and decrypts the encrypted personal information using the decryption key.

<Structure>

<Structure of Mobile Device 20>

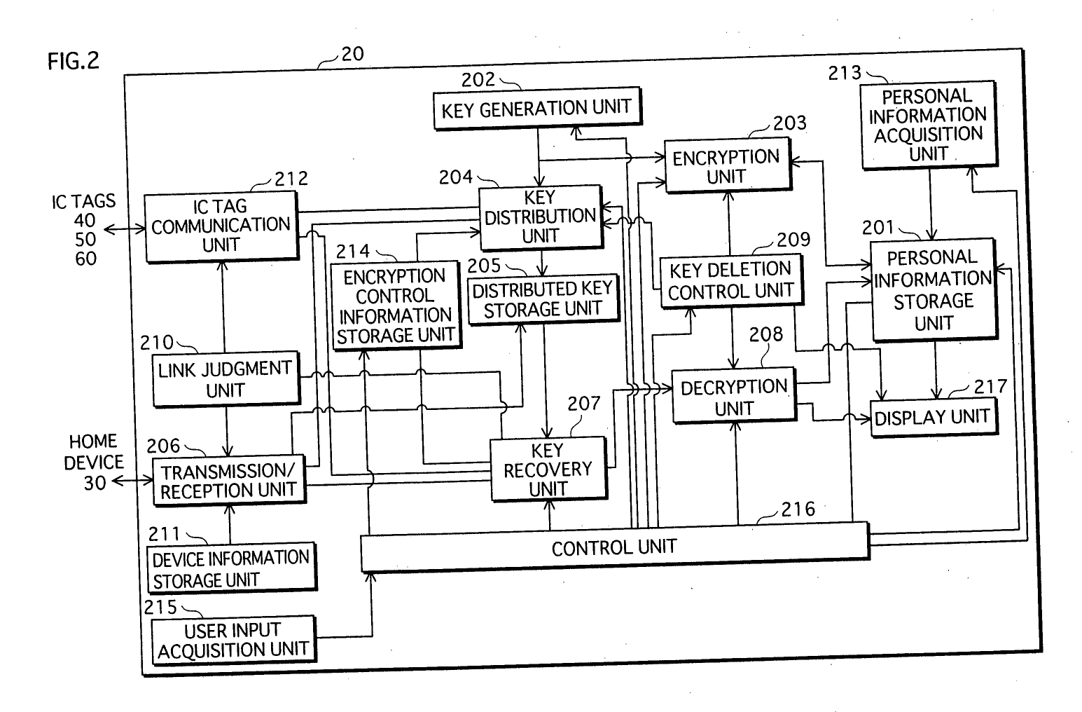

As shown in FIG. 2, the mobile device 20 is composed of a personal information storage unit 201, a key generation unit 202, an encryption unit 203, a key distribution unit 204, a distributed key storage unit 205, a transmission/reception unit 206, a key recovery unit 207, a decryption unit 208, a key deletion control unit 209, a link judgment unit 210, a device information storage unit 211, an IC tag communication unit 212, a personal information acquisition unit 213, an encryption control information storage unit 214, a user input acquisition unit 215, a control unit 216, and a display unit 217.

The mobile device 20 is specifically a computer system composed of a microprocessor, a ROM (Read Only Memory), a RAM (Random Access Memory), and the like. A computer program is stored on the RAM. Functions of the mobile device 20 are achieved by the microprocessor operating in accordance with the computer program.

The device information storage unit 211 is composed of a ROM, and stores device identification information “DID_{—}1” identifying the mobile device 20.

The device identification information is prewritten to the device information storage unit 211 before shipment of the mobile device 20.

The encryption control information storage unit 214 stores encryption control information written by the control unit 216, which is a parameter for encrypting the personal information.

The encryption control information includes an encryption control information number that is a number identifying the encryption control information, key identification information that is identification information identifying a key used for encryption, a key distribution type that is a type of a method of holding a distributed key distributed from an encryption key, the number of distributed keys that is a number showing the number of distributed keys distributed from an encryption key, a key threshold value that is a value showing the number of distributed keys needed for recovering the encryption key among a plurality of distributed keys, and key storage destination information showing a device to hold (the number of distributed keys-1) distributed keys.

The key distribution type having a value “1” shows a method of holding a distributed key in a device connected via the wireless LAN, whereas the key distribution type having a value “2” shows a method of holding a distributed key in an IC tag.

In this embodiment, the device connected via the wireless LAN is the home device 30 identified by device identification information “DID_{—}2”.

When the key distribution type has a value “1”, the key storage destination information shows device identification information identifying a device connected via the wireless LAN. Whereas, when the key distribution type has a value “2”, the key storage destination information shows a tag ID identifying an IC tag.

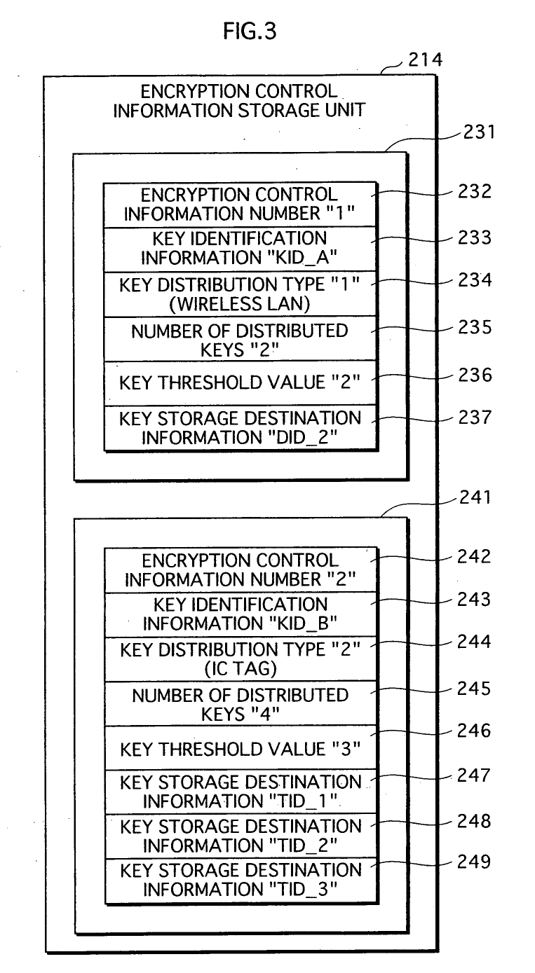

The encryption control information storage unit 214 stores two pieces of encryption control information: encryption control information 231 and encryption control information 241, as one example shown in FIG. 3.

The encryption control information 231 includes an encryption control information number “1” (232) identifying the encryption control information, key identification information “KID_A” (233), a key distribution type “1” (234), the number of distributed keys “2” (235), a key threshold value “2” (236), and key storage destination information “DID_{—}2” (237).

The key storage destination information “DID_{—}2” is device identification information identifying the home device 30, and is also held in the home device 30.

The encryption control information 241 includes an encryption control information number “2” (242) identifying the encryption control information, key identification information “KID_B” (243), a key distribution type “2” (244), the number of distributed keys “4” (245), a key threshold value “3” (246), key storage destination information “TID_{—}1” (247), key storage destination information “TID_{—}2” (248), and key storage destination information “TID_{—}3” (249).

The Key storage destination information “TID_{—}1” is a tag ID identifying the IC tag 40, and is also held in the IC tag 40.

Similarly, the key storage destination information “TID_{—}2” is a tag ID identifying the IC tag 50, and is also held in the IC tag 50, and the key storage destination information “TID_{—}3” is a tag ID identifying the IC tag 60, and is also held in the IC tag 60.

The personal information acquisition unit 213 is specifically the digital camera, photographs an image upon receiving a photographing instruction from the control unit 216. And then, the personal information acquisition unit 213 randomly generates a personal information name that is a name of the photographed image, generates a personal information file including the personal information name, the encryption control information number having a value “0” showing no encryption, and the image, and writes the personal information file to the personal information storage unit 201.

Note that the personal information acquisition unit 213 generates a personal information name different from those stored on the personal information storage unit 201.

The encryption control information number included in the personal information file correlates the personal information file with encryption control information including an encryption control information number having a same value stored on the encryption control information storage unit 214.

Upon receiving a key generation instruction including the encryption control information number from the control unit 216, the key generation unit 202 randomly generates an encryption key, transmits the generated encryption key to the encryption unit 203, and transmits the encryption key and the encryption control information number to the key distribution unit 204.

The encryption unit 203 receives the personal information name from the control unit 216, and receives the encryption key from the key generation unit 202.

The encryption unit 203 reads personal information identified by the received personal information name from the personal information storage unit 201, generates encrypted personal information by applying an encryption algorithm E1 to the read personal information using the received encryption key, and overwrites the encrypted personal information on the personal information corresponding to the personal information name stored on the personal information storage unit 201.

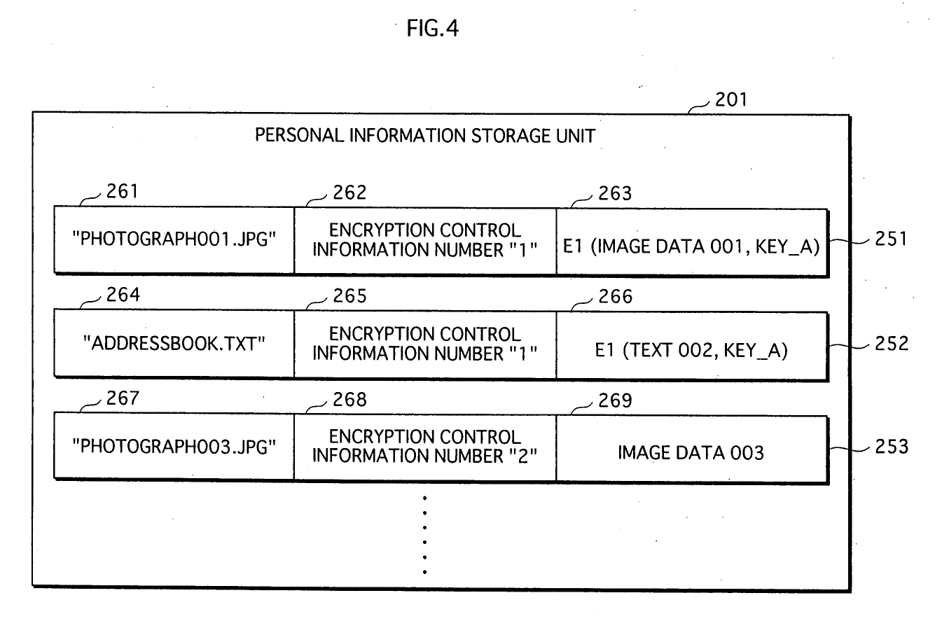

The personal information storage unit 201 is specifically a non-volatile memory, and stores a personal information file. As one example, the personal information storage unit 201 stores personal information files 251 to 253 shown in FIG. 4. The personal information file 251 includes a personal information name “photograph001.JPG” (261), an encryption control identification number “1” (262), and personal information “E1 (image data 001, KEY_A)” (263).

Here, the E1 (data, key) shows encrypted data generated by applying the encryption algorithm E1 to the data using the key.

The personal information file 252 includes a personal information name “addressbook.TXT” (264), an encryption control identification number “1” (265), and personal information “E1 (text 002, KEY_A)” (266).

The personal information file 253 includes a personal information name “photograph003.JPG” (267), an encryption control identification number “2” (268), and personal information “image data 003” (269).

The non-volatile memory is difficult to be removed from the mobile device 20.

The key distribution unit 204 receives the encryption key and the encryption control information number from the key generation unit 202, and distributes the received encryption key into n distributed keys (n is a natural number) as described later.

Key distribution is performed based on Shamir's threshold secret sharing scheme disclosed in “How to Share a Secret” by A. Shamir, Comm. Assoc. Comput. Mach., vol. 22, no. 11, pp. 612-613, 1979.

In this scheme, a distributed key is given by k points on a curve of degree k-1 having an encryption key S as a y-intercept. Given k arbitrary distributed keys, the curve of degree k-1 is determined. Thereby, the encryption key S that is the y-intercept can be given.

For example, suppose k set as two. Given two distributed keys, a first degree curve (=a straight line) passing through two points that are the two distributed keys is determined, and the encryption key S that is the y-intercept is given.

However, given only one of the two distributed keys, the straight line cannot be determined, thereby the encryption key S cannot be given. “How to Share a Secret” describes this in detail. Also, when a distributed key is given by n (n is a natural number) points greater than k, the encryption key S that is the y-intercept can be given by collecting k distributed keys among the n distributed keys.

The key distribution unit 204 generates a distributed key according to the following steps.

(1) Randomly select a prime number p that satisfies p>max (S,n), for the received encryption key S. Where max (S,n) shows a greater one of S and n.

(2) Where a₀=S, and randomly select (k-1) independent coefficients a₁, . . . , aₖ₋₁(0≦aⱼ≦p−1). Note, aₖ₋₁≠0.

(3) Calculate a polynomial f(x)=a₀x⁰+a₁x¹+ . . . +aₖ₋₁x^{k-1} for Si=f(i) mod p (1≦i≦n). A distributed key is given by a pair of i and Sᵢ(i,Sᵢ).

Here, n represents the number of distributed keys included in the encryption control information stored on the encryption control information storage unit 214 corresponding to the received encryption control information number, and k represents the key threshold value included in the encryption control information.

The key distribution unit 204 receives the encryption key from the key generation unit 202, and stores one among the generated n distributed keys on the distributed key storage unit 205, in correspondence with the key identification information included in the encryption control information.

For example, when the received encryption control information number has a value “1”, the key distribution unit 204 references the encryption control information 231 including the encryption control information number 232 having a value “1”, and acquires “2” that is a value of the number of distributed keys 235 as n, and “2” that is a value of the key threshold value 236 as k.

The key distribution unit 204 generates two distributed keys: “KEY_A1” and “KEY_A2” from the encryption key, and transmits “KEY_A2” to the distributed key storage unit 205, together with the key identification information “KID_A” (233) included in the encryption control information 231.

Here, “KEY_A1” is given by (1,S₁), and “KEY_A2” is given by (2,S₂), as described above.

Next, the key distribution unit 204 transmits a transmission instruction including “KEY_A1”, the key storage destination information “DID_{—}2”. (237) included in the encryption control information 231, and the key identification information “KID_A” (233) included in the encryption control information 231, to the transmission/reception unit 206, in order to perform transmission using the wireless LAN shown by the key distribution type “1” (234) included in the encryption control information 231.

Also, when the received encryption control information number has a value “2”, the key distribution unit 204 references the encryption control information 241 including the encryption control information number 242 having a value “2”, and acquires “4” that is a value of the number of distributed keys 245 as n, and “3” that is a value of the key threshold value 246 as k.

The key distribution unit 204 generates four distributed keys: “KEY_B1”, “KEY_B2”, “KEY_B3”, and “KEY_B4”, from the encryption key, and stores “KEY_B4” on the distributed key storage unit 205, together with the key identification information “KID_B” (243) included in the encryption control information 241.

Next, the key distribution unit 204 transmits a transmission instruction including “KEY_B1”, the key storage destination information “TID_{—}1” (247) included in the encryption control information 241, and the key identification information “KID_B” (243) included in the encryption control information 241, to the IC tag communication unit 212, in order to perform transmission using the wireless communication to an IC tag shown by the key distribution type “2” (244) included in the encryption control information 241.

The key distribution unit 204 transmits a transmission instruction including “KEY_B2”, “TID_{—}2”, and “KID_B” to the IC tag communication unit 212, and transmits a transmission instruction including “KEY_B3”, “TID_{—}3”, and “KID_B” to the IC tag communication unit 212.

The distributed key storage unit 205 is a non-volatile memory, and stores key identification information and a distributed key that are written by the key distribution unit 204, in correspondence with each other.

Also, the distributed key storage unit 205 stores key identification information and a distributed key acquired from an external device via the transmission/reception unit 206, in correspondence with each other.

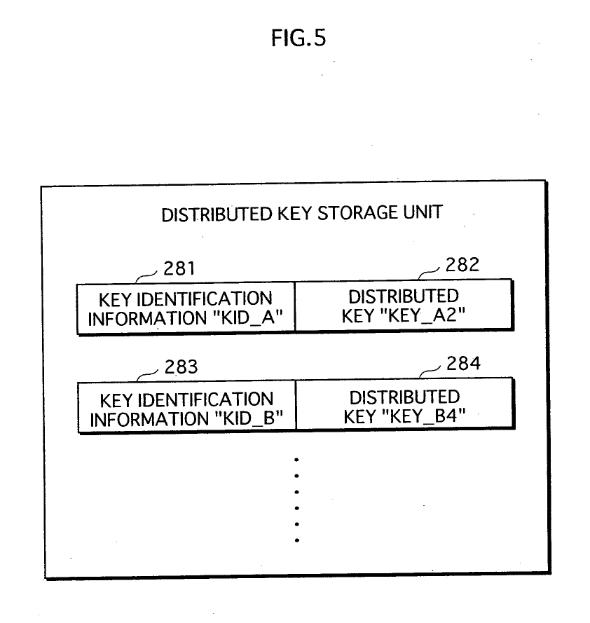

As one example shown in FIG. 5, the distributed key storage unit 205 stores key identification information “KID_A” (281) and a distributed key “KEY_A2” (282) in correspondence with each other, and stores key identification information “KID_B” (283) and a distributed key “KEY_B4” (284) in correspondence with each other.

The IC tag communication unit 212 receives the transmission instruction including the distributed key, the key storage destination information, and the key identification information, from the key distribution unit 204, and transmits the key identification information and the distributed key to the IC tag identified by the key storage destination information using the wireless communication.

Also, the IC tag communication unit 212 receives a reading instruction including the key storage destination information from the key recovery unit 207, and attempts to read the key identification information and the distributed key that are stored on the IC tag identified by the key storage destination information, using the wireless communication.

When the key identification information and the distributed key can be read, the IC tag communication unit 212 transmits the read distributed key and the read key identification information to the key recovery unit 207. When the key identification information and the distributed key cannot be read, the IC tag communication unit 212 transmits the key identification information and the distributed key having a value “0” showing error, to the key recovery unit 207.

Also, when receiving a reading request including key storage destination information from the link judgment unit 210, the IC tag communication unit 212 attempts to read a tag ID from an IC tag identified by the key storage destination information.

When the tag ID can be read, the IC tag communication unit 212 transmits a reading response including the read tag ID to the link judgment unit 210. When the tag ID cannot be read, the IC tag communication unit 212 transmits a reading response including a value “0” as the tag ID to the link judgment unit 210.

The transmission/reception unit 206 receives the transmission instruction including the distributed key, the key storage destination information, and the key identification information, from the key distribution unit 204, and transmits the distributed key, the key storage destination information, and the key identification information, to a device identified by the key storage destination information, using the wireless LAN.

Also, the transmission/reception unit 206 receives a reading instruction including key storage destination information from the key recovery unit 207, and transmits a distributed key reading instruction including the key storage destination information and key identification information, to a device identified by the key storage destination information, using the wireless LAN.

When a distributed key reading response, as a response to the distributed key reading instruction, including the key storage destination information, the key identification information, and the distributed key, can be received from the device, the transmission/reception unit 206 transmits the key identification information and the distributed key that are included in the distributed key reading response, to the key recovery unit 207.

When the distributed key reading response cannot be received, the transmission/reception unit 206 transmits the key identification information and the distributed key having a value “0”, to the key recovery unit 207.

The link judgment unit 210 receives a link judgment instruction including a key distribution type and key storage destination information from the control unit 216, and judges whether a link is established with a device shown by the received key storage destination information.

When the key distribution type shows the home device 30, the link judgment unit 210 reads the device identification information “DID_{—}1” from the device information storage unit 211, transmits a response request packet including the device identification information “DID_{—}1” to the home device 30 via the transmission/reception unit 206, and measures a time period until a response packet to the transmitted response request packet returns from the home device 30. When the measured time period is within a predetermined time period (for example, within one second), the link judgment unit 210 judges that the link is established, thereby the mobile device 20 is found to be inside the home where the home device 30 is disposed.

Also, when the key storage destination information shows the IC tag, the link judgment unit 210 transmits a reading request including the key storage destination information to the IC tag communication unit 212.

The link judgment unit 210 receives a reading response as a response to the reading request, from the IC tag communication unit 212.

When the reading response includes a same tag ID as that shown by the key storage destination information, the link judgment unit 210 judges that the link is established. When the reading response does not include the same tag ID, the link judgment unit 210 judges that the link is not established.

The user input acquisition unit 215 includes various keys such as a power supply key, an encryption control information input start key, an encryption control information input end key, a camera photographing key, a menu key, a ten key, an alphabet key, a selection key, and a cursor key. The user input acquisition unit 215 detects a key operation by the user, and outputs information corresponding to the detected key operation, to the control unit 216.

For example, the user presses the encryption control information input start key, and then inputs “1” for a key distribution type, inputs “2” for the number of distributed keys, inputs “2” for a key threshold value, inputs “DID_{—}2” for key storage destination information, and presses the encryption control information input end key.

The user input acquisition unit 215, in accordance with the input, transmits an encryption control information input start instruction, the key distribution type, the number of distributed keys, the key threshold value, the key storage destination information, and an encryption input end instruction, in this order, to the control unit 216.

When detecting a pressing of the camera photographing key, the user input acquisition unit 215 transmits a camera photographing instruction to the control unit 216.

The user input acquisition unit 215 receives an input of an encryption control information number, and transmits the encryption control information number to the control unit 216.

The user input acquisition unit 215 receives an input of a personal information name showing encrypted personal information to be decrypted, by the key operation of the user, and transmits the personal information name to the control unit 216.

The key deletion control unit 209 deletes the encryption key remaining in the key generation unit 202, the key distribution unit 204, and the encryption unit 203, deletes the distributed key remaining in the key distribution unit 204, deletes the decryption key and the distributed key remaining in the key recovery unit 207, and deletes the decryption key remaining in the decryption unit 208.

The key deletion control unit 209 receives the key identification information from the key distribution unit 204, deletes the encryption key remaining in the key generation unit 202 and the key distribution unit 204, and deletes the distributed key remaining in the key distribution unit 204.

Also, the key deletion control unit 209 periodically transmits a link judgment request to the link judgment unit 210. When the number of established links reaches less than the key threshold value, the key deletion control unit 209 deletes the encryption key in the encryption unit 203, and instructs the display unit 217 to stop displaying the personal information being displayed.

The key recovery unit 207 receives the personal information name showing the encrypted personal information to be decrypted from the control unit 216.

The key recovery unit 207 acquires a personal information file including the personal information name from the personal information storage unit 201, and extracts an encryption control information number from the acquired personal information file.

Next, the key recovery unit 207 reads encryption control information identified by the extracted encryption control information number from the encryption control information storage unit 214.

The key recovery unit 207 attempts to acquire a distributed key from each of devices shown by (the number of distributed keys-1) pieces of key storage destination information included in the read encryption control information. When succeeding in acquisition of the distributed keys no less than the key threshold value including the distributed key stored on the distributed key storage unit 205, the key recovery unit 207 recovers a decryption key using the acquired distributed keys, and transmits the recovered decryption key and the personal information name to the decryption unit 208.

For example, when the encryption control information number has a value “1”, the key recovery unit 207 transmits a distributed key reading instruction including the key identification information “KID_A” (233) and the key storage destination information “DID_{—}2” (237) to the transmission/reception unit 206.

The key recovery unit 207 receives, as a response to the distributed key reading instruction, a distributed key reading response including the key identification information “KID_A” (233), the key storage destination information “DID_{—}2” (237), and the distributed key, from the transmission/reception unit 206.

Note that, when the transmission/reception unit 206 cannot receive the distributed key “KEY_A1” from the home device 30, the key recovery unit 207 receives a distributed key (0,0) from the transmission/reception unit 206.

When receiving a distributed key other than (0,0) from the transmission/reception unit 206, the key recovery unit 207 reads a distributed key corresponding to the key identification information “KID_A” from the distributed key storage unit 205. The key recovery unit 207 can acquire “2” or more distributed keys, a value “2” being a value of the key threshold value 236 included in the encryption control information 231. The key recovery unit 207 generates an encryption key “KEY_A” using the distributed key “KEY_A1” acquired from the home device 30 and the distributed key “KEY_A2” read from the distributed key storage unit 205, and transmits the recovered decryption key and the personal information name to the decryption unit 208.

Similarly, for example, when the encryption control information number has a value “2”, the key recovery unit 207 transmits a distributed key reading instruction including the key identification information “KID_B” (243) and the key storage destination information “TID_{—}1” (247) to the IC tag communication unit 212.

The key recovery unit 207 receives, as a response to the distributed key reading instruction, a distributed key reading response including the key identification information “KID_B” (243), the key storage destination information “TID_{—}1” (247), and the distributed key “KEY_B1”, from the IC tag communication unit 212.

Note that, when the IC tag communication unit 212 cannot receive the distributed key from the IC tag 40 having the tag ID “TID_{—}1”, the key recovery unit 207 receives not the distributed key “KEY_B1” but a distributed key (0,0). When receiving a distributed key other than (0,0), the key recovery unit 207 holds the received distributed key.

Similarly, the key recovery unit 207 transmits a distributed key reading instruction including the key identification information “KID_B” (243) and the key storage destination information “TID_{—}2” (248) to the IC tag communication unit 212, and receives, as a response to the distributed key reading instruction, a distributed key reading response including the key identification information “KID_B” (243), the key storage destination information “TID_{—}2” (248), and the distributed key “KEY_B2”, from the IC tag communication unit 212.

Note that, when the IC tag communication unit 212 cannot receive the distributed key, the key recovery unit 207 receives not the distributed key “KEY_B2” but a distributed key (0,0). When receiving a distributed key other than (0,0), the key recovery unit 207 holds the received distributed key.

Similarly, the key recovery unit 207 transmits a distributed key reading instruction including the key identification information “KID_B” (243) and the key storage destination information “TID_{—}3” (249) to the IC tag communication unit 212, and receives, as a response to the distributed key reading instruction, a distributed key reading response including the key identification information “KID_B” (243), the key storage destination information “TID_{—}3” (249), and the distributed key “KEY_B3”, from the IC tag communication unit 212.

Note that, when the IC tag communication unit 212 cannot receive the distributed key, the key recovery unit 207 receives not the distributed key “KEY_B3” but a distributed key (0,0). When receiving a distributed key other than (0,0), the key recovery unit 207 holds the received distributed key.

The key recovery unit 207 reads the distributed key “KEY_B4” corresponding to the key identification information “KID_B” from the distributed key storage unit 205.

When “3” or more distributed keys can be acquired, the key recovery unit 207 recovers a decryption key “KEY_B” using three of the acquired distributed keys among distributed keys: “KEY_B1”, “KEY_B2”, “KEY_B3”, and “KEY_B4”, a value “3” being a value of the key threshold value 246 included in the encryption control information 241. The key recovery unit 207 transmits the recovered decryption key and the personal information name to the decryption unit 208.

Here, the key recovery unit 207 specifically recovers the decryption key using Lagrange's interpolation formula. Since Lagrange's interpolation formula is used widely, detail description will be omitted.

The key recovery unit 207 performs an operation on a decryption key P (0), for k acquired distributed keys (xⱼ, fⱼ) (1≦j≦k) among n distributed keys generated by the key distribution unit 204 (i,Si) (1≦i≦n), based on the following interpolation curve of degree k-1 passing through all k coordinate points.
P(x)=f₁(g₁(x)/g₁(x₁))+ . . . fₖ(gₖ(x)/gₖ(xₙ))mod p
Where, gⱼ(x)=L(x)/(x−xⱼ)(1≦j≦k), and
L(x)=(x−x₁)(x−x₂) . . . (x−xₖ)

The decryption unit 208 receives the personal information name and the decryption key from the key recovery unit 207.

The decryption unit 208 reads the encrypted personal information identified by the received personal information name from the personal information storage unit 201, generates the personal information by applying a decryption algorithm D1 to the read encrypted personal information using the received decryption key, and overwrites the generated personal information on the encrypted personal information corresponding to the personal information name stored on the personal information storage unit 201.

Here, the decryption algorithm D1 is an algorithm for decrypting an encrypted text generated by the encryption algorithm E1. An encryption key used for the encryption algorithm E1 and a decryption key used for the decryption algorithm D1 are identical with each other.

The control unit 216 controls a whole operation of the mobile device 20.

The control by the control unit 216 will be described relating to a key generation preprocessing, encryption control, and decryption control, respectively.

(Key Generation Preprocessing)

The control unit 216 receives the encryption control information input start instruction, the key distribution type, the number of distributed keys, the key threshold value, the key storage destination information, and the encryption input end instruction, from the user input acquisition unit 215. The control unit 216 generates an encryption control information number and key identification information so as to be only one in the mobile device 20, generates encryption control information including the generated encryption control information number, the key identification information, the received key distribution type, the number of distributed keys, the key threshold value, and the key storage destination information, and stores the generated encryption control information on the encryption control information storage unit 214.

When receiving the camera photographing instruction from the user input acquisition unit 215, the control unit 216 transmits the photographing instruction to the personal information acquisition unit 213. After the personal information acquisition unit 213 generates the personal information file including the photographed image and the encryption control information number having a value “0” showing no encryption, the control unit 216 receives the encryption control information number from the user input acquisition unit 215, and rewrites the encryption control information number having a value “0” included in the personal information file with the received encryption control information number.

(Encryption Control)

The control unit 216 judges whether a personal information file including an encryption control information number having a value other than “0” and unencrypted personal information is stored on the personal information storage unit 201, reads the personal information file from the personal information storage unit 201, and transmits a personal information name to the encryption unit 203.

The control unit 216 reads encryption control information shown by the encryption control information number included in the read personal information file, from the encryption control information storage unit 214.

The control unit 216 transmits the link judgment instruction including the key distribution type and the key storage destination information, for (the number of distributed keys-1) pieces of key storage destination information included in the read encryption control information, to the link judgment unit 210.

When the link judgment unit 210 judges that a link is established with a device identified by all the pieces of key storage destination information, the control unit 216 transmits a key generation instruction including a key control information number to the key generation unit 202. The encryption unit 203 encrypts the personal information, with a trigger of transmission of the key generation instruction from the control unit 216 to the key generation unit 202.

(Decryption Control)

The control unit 216 receives a personal information name showing personal information to be decrypted from the user input acquisition unit 215, and transmits the personal information name to the decryption unit 208. Also, the control unit 216 reads a personal information file including the personal information name from the personal information storage unit 201, extracts an encryption control information number included in the personal information file, and transmits the encryption control information number to the key recovery unit 207. The decryption unit 208 decrypts the encrypted personal information, with a trigger of transmission of the encryption control information number from the control unit 216 to the key recovery unit 207.

The display unit 217 displays a character, an image, video, and the like.

<Structure of Home Device 30>

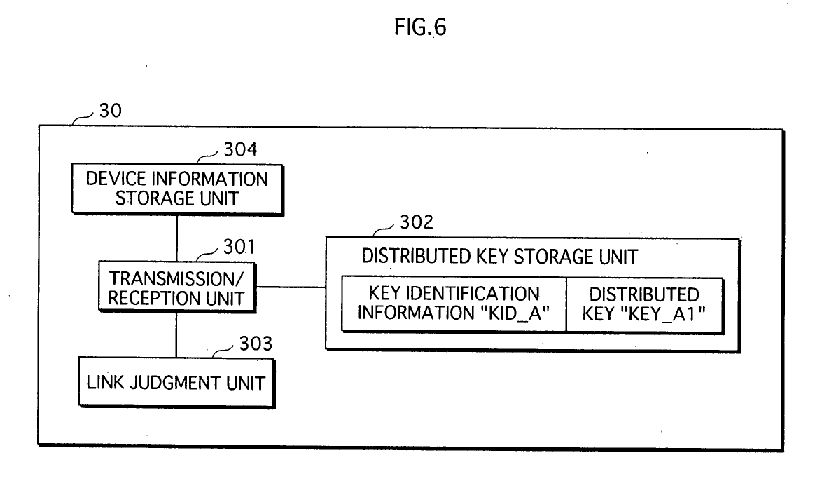

The home device 30 is composed of a transmission/reception unit 301, a distributed key storage unit 302, a link judgment unit 303, and a device information storage unit 304, as shown in FIG. 6.

The home device 30 is specifically a computer system composed of a microprocessor, a ROM, a RAM, and the like. A computer program is stored on the RAM. Functions of the mobile device 30 are achieved by the microprocessor operating in accordance with the computer program.

The transmission/reception unit 301 communicates with the mobile device 20 using the wireless LAN.

The transmission/reception unit 301 receives device identification information that is key storage destination information, key identification information, and a distributed key from the mobile device 20, and stores the received key identification information and distributed key in correspondence with each other, on the distributed key storage unit 302.

Also, the transmission/reception unit 301 receives a distributed key reading instruction including device identification information that is key storage destination information, and key identification information from the mobile device 20.

When receiving the reading instruction, the transmission/reception unit 301 reads the distributed key corresponding to the key identification information included in the reading instruction from the distributed key storage unit 302, reads the device identification information “DID_{—}2” from the device information storage unit 304, and transmits a distributed key reading response including the read device identification information, key identification information, and distributed key.

The distributed key storage unit 302 stores the key identification information written by the transmission/reception unit 301 and the distributed key in correspondence with each other.

The link judgment unit 303 receives a response request packet including the device identification information “DID_{—}1” identifying the mobile device 20 from the mobile device 20 via the transmission/reception unit 301, reads the device identification information “DID_{—}2” from the device information storage unit 304, and transmits a response packet including the device identification information “DID_{—}2” to the mobile device 20 identified by the device identification information “DID_{—}1”.

The device information storage unit 304 is composed of a ROM, and stores the device identification information “DID_{—}2” identifying the home device 30.

The device identification information is prewritten in the device information storage unit 304 before shipment of the home device 30.

<Structures of IC Tags 40, 50, and 60>

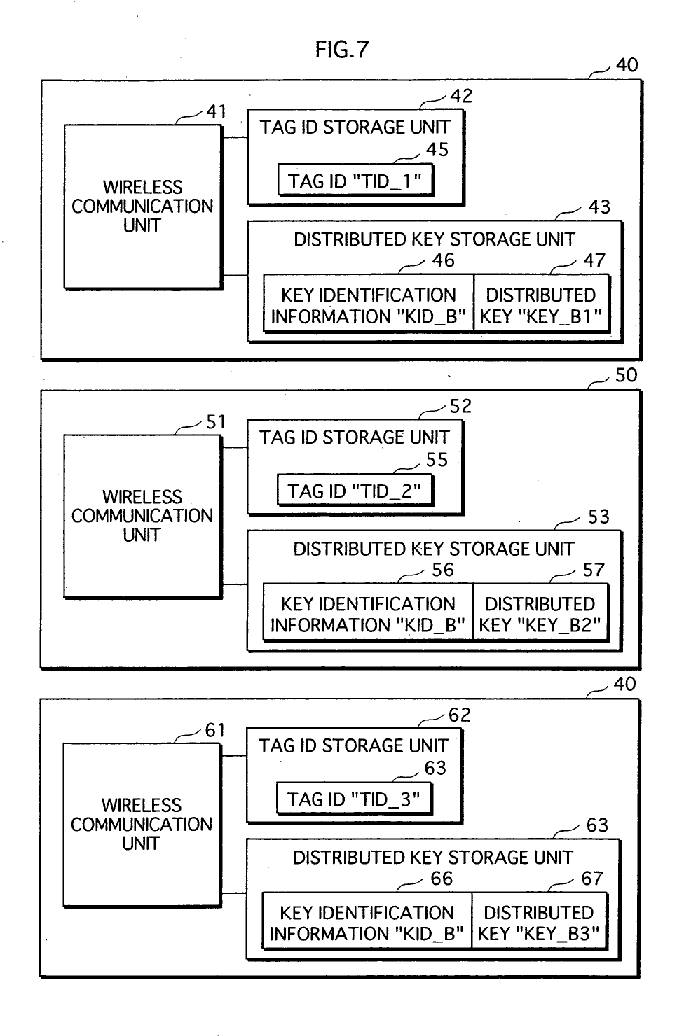

The IC tag 40 is composed of a wireless communication unit 41, a tag ID storage unit 42, and a distributed key storage unit 43, as shown in FIG. 7.

The wireless communication unit 41 communicates with the mobile device 20 via the wireless.

The tag ID storage unit 42 is composed of a ROM, and stores a tag ID “TID_{—}1” (45) identifying the IC tag 40. The tag ID is prewritten in the tag ID storage unit 42 before shipment of the IC tag 40.

The mobile device 20 reads the tag ID “TID_{—}1” (45) from the tag ID storage unit 42 via the wireless communication unit 41.

The distributed key storage unit 43 stores the key identification information and the distributed key written by the mobile device 20 via the wireless communication unit 41. The distributed key storage unit 43 stores key identification information “KID_B” (46) and a distributed key “KEY_B1 (47)” in correspondence with each other, as one example shown in FIG. 7.

The IC tag 50 has a same structure as that of the IC tag 40 as shown in FIG. 7, and is composed of a wireless communication unit 51, a tag ID storage unit 52, and a distributed key storage unit 53. The tag ID storage unit 52 stores a tag ID “TID_{—}2” (55). The distributed key storage unit 53 stores, as one example, key identification information “KID_B” (56) and a distributed key “KEY_B2” (57) in correspondence with each other.

The IC tag 60 has the same structure as that of the IC tag 40, and is composed of a wireless communication unit 61, a tag ID storage unit 62, and a distributed key storage unit 63, as shown in FIG. 7. The tag ID storage unit 62 stores a tag ID “TID_{—}3” (65). The distributed key storage unit 63 stores, as one example, key identification information “KID_B” (66) and a distributed key “KEY_B3” (67) in correspondence with each other.

Descriptions of the IC tags 50 and 60 other than the above will be omitted because of overlapping with that of the IC tag 40.

<Operation>

Operation of the personal information management system 1 will be described as the following, respectively, a key recovering preprocessing for recovering a decryption key, an encryption processing for encrypting personal information, and a decryption processing for decrypting the encrypted personal information.

<Key Generation Preprocessing>

The user of the mobile device 20 inputs encryption control information using the key included in the user input acquisition unit 215.

For example, the user presses the encryption control information input start key, and then inputs “1” for a key distribution type, inputs “2” for the number of distributed keys, inputs “2” for a key threshold value, inputs “DID_{—}2” for key storage destination information, and presses the encryption control information input end key.

The user input acquisition unit 215 transmits the key distribution type, the number of distributed keys, the key threshold value, and the key storage destination information that are inputted for the encryption control information, to the control unit 216.

The control unit 216 receives the key distribution type, the number of distributed keys, the key threshold value, and the key storage destination information from the user input acquisition unit 215, and randomly generates an encryption control information number and key identification information. And then, the control unit 216 generates the encryption control information as already shown in FIG. 3, including the key distribution type, the number of distributed keys, the key threshold value, the key storage destination information, the generated encryption control information number, and the generated key identification information, and stores the encryption control information on the encryption control information storage unit 214.

The user of the mobile device 20 presses the camera photographing key included in the user input acquisition unit 215 outside the home.

The user input acquisition unit 215 detects the pressing of the camera photographing key, and transmits the camera photographing instruction to the control unit 216.

The control unit 216 transmits the camera photographing instruction to the personal information acquisition unit 213.

Upon receiving the camera photographing instruction from the control unit 216, the personal information acquisition unit 213 photographs an image, randomly generates a personal information name that is a name of the photographed image, generates a personal information file including the personal information name, the encryption control information number having a value “0” showing no encryption, and the image, and writes the personal information file to the personal information storage unit 201.

After photographing the image, when the user wants the photographed image to be encrypted, the user inputs an encryption control information number using the key included in the user input acquisition unit 215.

The user input acquisition unit 215 transmits the encryption control information number to the control unit 216. The control unit 216 receives the encryption control information number from the user input acquisition unit 215, and rewrites the encryption control information number included in the personal information file generated by the personal information acquisition unit 213, from a value “0” to the received encryption control information number.

Here, instead of receiving the encryption control information number from the user input acquisition unit 215, the control unit 216 can rewrite the encryption control information number included in the personal information file generated by the personal information acquisition unit 213, from a value “0” to an encryption control information number pre-held in the control unit 216. The user pre-selects whether the control unit 216 receives the encryption control information number from the user input acquisition unit 215.

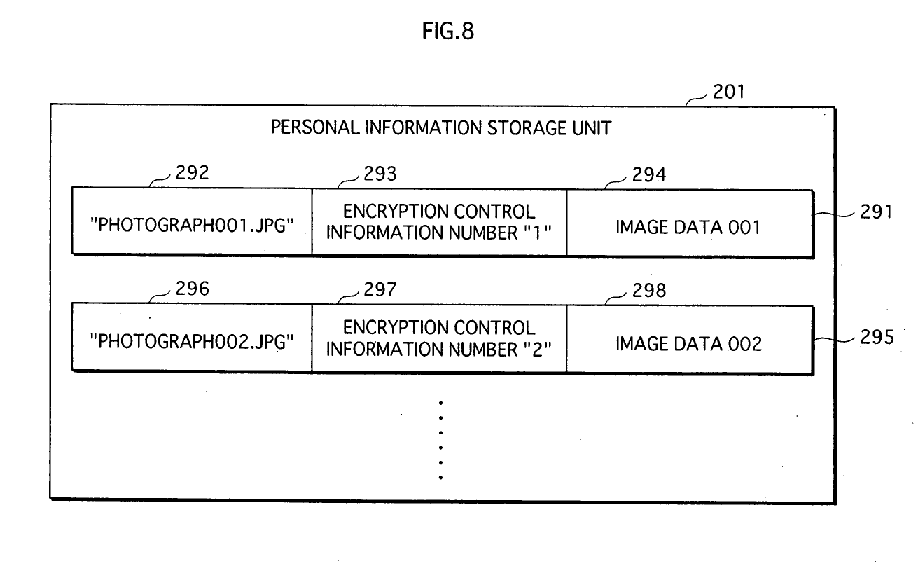

According to the key generation preprocessing described above, the encryption control information storage unit 214 stores the encryption control information as shown in FIG. 3, and the personal information storage unit 201 stores a personal information file 291 and a personal information file 295 as shown in FIG. 8.

The personal information file 291 includes an image data 001 (294), a personal information name “photograph001.JPG” (292) identifying the image data 001 (294), and an encryption control information number “1” (293) relating to encryption of the image data 001 (294). The personal information file 295 includes an image data 002 (298), a personal information name “photograph002.JPG” (296) identifying the image data 002 (298), and an encryption control information number “2” (297) relating to encryption of the image data 002 (298).

<Encryption Processing>

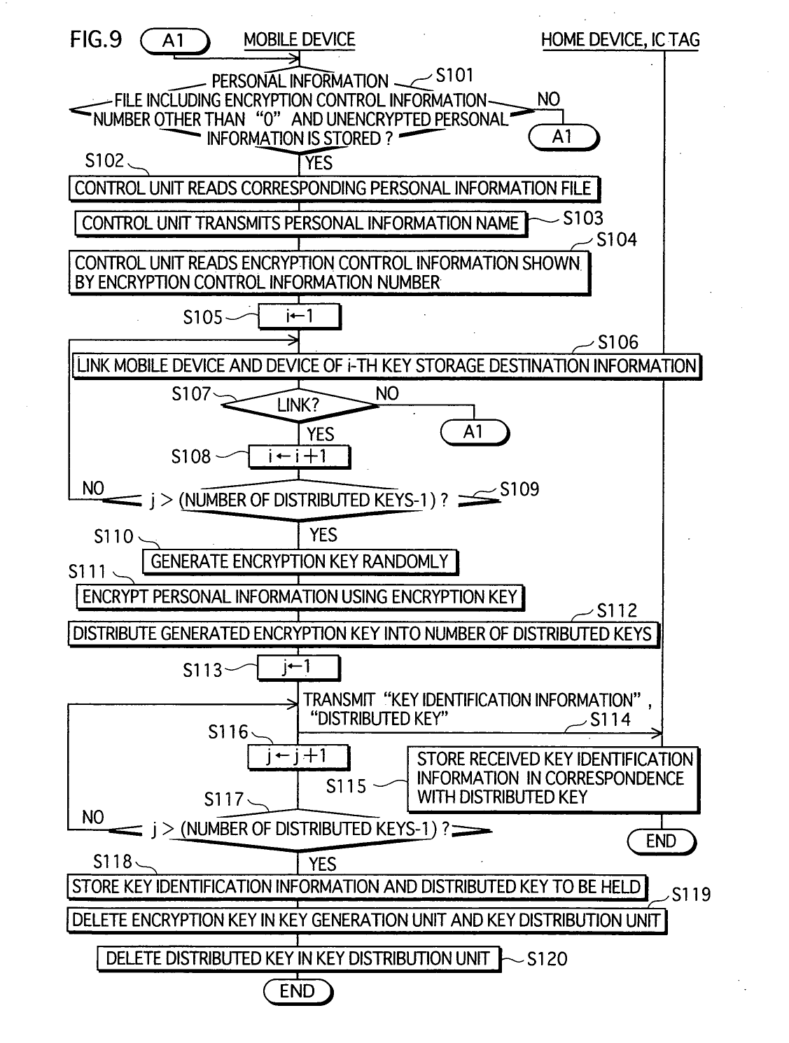

Generation of an encryption key relating to the personal information generated in the key generation preprocessing and encryption processing will be described with reference to FIG. 9.

In the mobile device 20, the control unit 216 judges whether a personal information file including an encryption control information number having a value other than “0” and unencrypted personal information is stored on the personal information storage unit 201 (Step S101).

When the personal information file is not stored in Step S101 (Step S101: NO), the control unit 216 repeats the processing of Step S101.

When the personal information file is stored in Step S101 (Step S101: YES), the control unit 216 reads the personal information file from the personal information storage unit 201 (Step S102).

The control unit 216 transmits a personal information name included in the read personal information file to the encryption unit 203 (Step S103).

The control unit 216 reads encryption control information shown by an encryption control information number included in the read personal information file from the encryption control information storage unit 214 (Step S104).

The control unit 216 initializes a value i that is an internal counter value by 1 (Step S105).

The control unit 216 transmits a link judgment instruction including a key distribution type and i-th key storage destination information that are included in the read encryption control information, to the link judgment unit 210.

The link judgment unit 210 attempts to establish a link with a device identified by the i-th key storage destination information as described above (Step S106).

When the link is not established (Step S107: NO), the processing returns to Step S101.

When the link is established (Step S107: YES), the link judgment unit 210 increments the internal counter value i by one (Step S108).

The control unit 216 judges whether the internal counter value i is greater than (the number of distributed keys included in the encryption control information-1) (Step S109).

When the value i is no more than (the number of distributed keys included in the encryption control information-1) (Step S109: NO), the processing moves to Step S106.

When the value i is greater than (the number of distributed keys included in the encryption control information-1) (Step S109: YES), the control unit 216 transmits a key generation instruction including a key control information number to the key generation unit 202.

The key generation unit 202 receives the key generation instruction, randomly generates an encryption key (Step S110), transmits the encryption control information number and the generated encryption key to the key distribution unit 204, and also transmits the encryption key to the encryption unit 203. The encryption unit 203 receives the encryption key from the key generation unit 202, reads personal information file corresponding to the personal information name from the personal information storage unit 201, and extracts the personal information to be encrypted from the personal information file.

The encryption unit 203 encrypts the personal information using the received encryption key to generate encrypted personal information, and replaces the personal information included in the personal information file corresponding to the personal information name stored on the personal information storage unit 201 with the encrypted personal information (Step S111).

The key distribution unit 204 receives the encryption control information number and the encryption key from the key generation unit 202, and reads the encryption control information identified by the received encryption control information number from the encryption control information storage unit 214.

The key distribution unit 204 distributes the encryption key into the number of distributed keys included in the read encryption control information (Step S112).

The key distribution unit 204 initializes an internal counter value j with a value “1” (Step S113).

The key distribution unit 204 transmits a transmission instruction including j-th key storage destination information and key identification information that are included in the encryption control information, and the distributed key to be stored on the device, to a communication unit corresponding to the key distribution type included in the encryption control information.

Here, when the key distribution type has a value “1”, the communication unit is the transmission/reception unit 206, which transmits the key identification information and the distributed key to a device shown by the j-th key storage destination information (Step S114).

The transmission/reception unit 301 of the home device 30 receives the key identification information and the distributed key, and stores the received key identification information and the received distributed key, in correspondence with each other, on the distributed key storage unit 302 (Step S115).

Also, when the key distribution type has a value “2”, the communication unit is the IC tag communication unit 212, which transmits the key identification information and the distributed key to an IC tag shown by the j-th key storage destination information.

A wireless communication unit of the IC tag shown by the j-th key storage destination information receives the key identification information and the distributed key, and stores the received key identification information and the received distributed key, in correspondence with each other, on a distributed key storage unit of the IC tag.

The key distribution unit 204 increments the internal counter value j by one (Step S116).

The key distribution unit 204 judges whether the value j is greater than (the number of distributed keys included in the encryption control information-1) (Step S117).

When the value j is no more than (the number of distributed keys included in the encryption control information-1) (Step S117: NO), the processing moves to Step S114.

When the value j is greater than (the number of distributed keys included in the encryption control information-1) (Step S117: YES), the key distribution unit 204 stores the key identification information and a distributed key to be stored thereon, in correspondence with each other, on the distributed key storage unit 205 (Step S118), and transmits a key deletion instruction including the encryption control information number to the key deletion control unit 209.

The key deletion control unit 209 receives the key identification information from the key distribution unit 204, and deletes the encryption keys remaining in the key generation unit 202 and the key distribution unit 204 (Step S119).

The key deletion control unit 209 deletes the distributed key remaining in the key distribution unit 204 (Step S120).

Here, main operations among the above-described Steps S101 to S120 will be supplementary described using an example of encryption of the image data 001 (294) included in the personal information file 291.

(Steps S101 and S102) The personal information file 291 including the encryption control information number having a value “1” and the image data 001 (294) that is unencrypted personal information is stored on the personal information storage unit 201 shown in FIG. 8. Thus, the control unit 216 judges that the corresponding personal information file 291 is stored, and reads the personal information file 291 from the personal information storage unit 201.

(Step S103) The control unit 216 transmits the “photograph001.JPG” (292) that is the personal information name included in the personal information file 291 to the encryption unit 203.

(Step S104) The control unit 216 reads the encryption control information 231 including the encryption control information number having a value “1” from the encryption control information storage unit 214.

(Step S106) The control unit 216 transmits a link judgment instruction including a key distribution type having a value “1”, and the key storage destination information “DID_{—}2” that is a first key storage destination information to the link judgment unit 210. The link judgment unit 210 attempts to establish a link with the home device 30 identified by the key storage destination information “DID_{—}2”. Here, the link is established.

(Step S110) The key generation unit 202 generates an encryption key “KEY_A”, transmits the encryption control information number having a value “1” and the generated encryption key “KEY_A” to the key distribution unit 204, and also transmits the encryption key “KEY_A” to the encryption unit 203.

(Step S111) The encryption unit 203 receives the encryption key “KEY_A” from the key generation unit 202, reads the personal information file 291 corresponding to the personal information name “photograph001.JPG” from the personal information storage unit 201, extracts the image data 001 (294) that is personal information to be encrypted from the personal information file. The encryption unit 203 encrypts the image data 001 (294) using the encryption key “KEY_A”, generates an E1 (image data 001, KEY_A) that is encrypted personal information, and replaces the image data 001 of the personal information file 291 stored on the personal information storage unit 201 with the E1 (image data 001, KEY_A).

(Step S112) The key distribution unit 204 receives the encryption control information number having a value “1” and the encryption key “KEY_A” from the key generation unit 202, and reads the encryption control information 231 identified by the encryption control information number having a value “1” from the encryption control information storage unit 214.

The key distribution unit 204 distributes the encryption key “KEY_A” into two distributed keys: “KEY_A1” and “KEY_A2” that are the number of distributed keys (235) included in the encryption control information 231.

(Step S114) The key distribution unit 204 transmits a transmission instruction including the first key storage destination information “DID_{—}2” and the key identification information “KID_A” that are included in the encryption control information 231 and the distributed key “KEY_A1” to be stored on the device, to the transmission/reception unit 206.

(Step S115) The transmission/reception unit 301 of the home device 30 identified by the key storage destination information “DID_{—}2” receives the key identification information and the distributed key, and stores the received key identification information and the distributed key, in correspondence with each other, on the distributed key storage unit 302.

(Step S118) The key distribution unit 204 stores the key identification information “KID_A” and the distributed key “KEY_A2”, in correspondence with each other, on the distributed key storage unit 205.

<Decryption Processing>

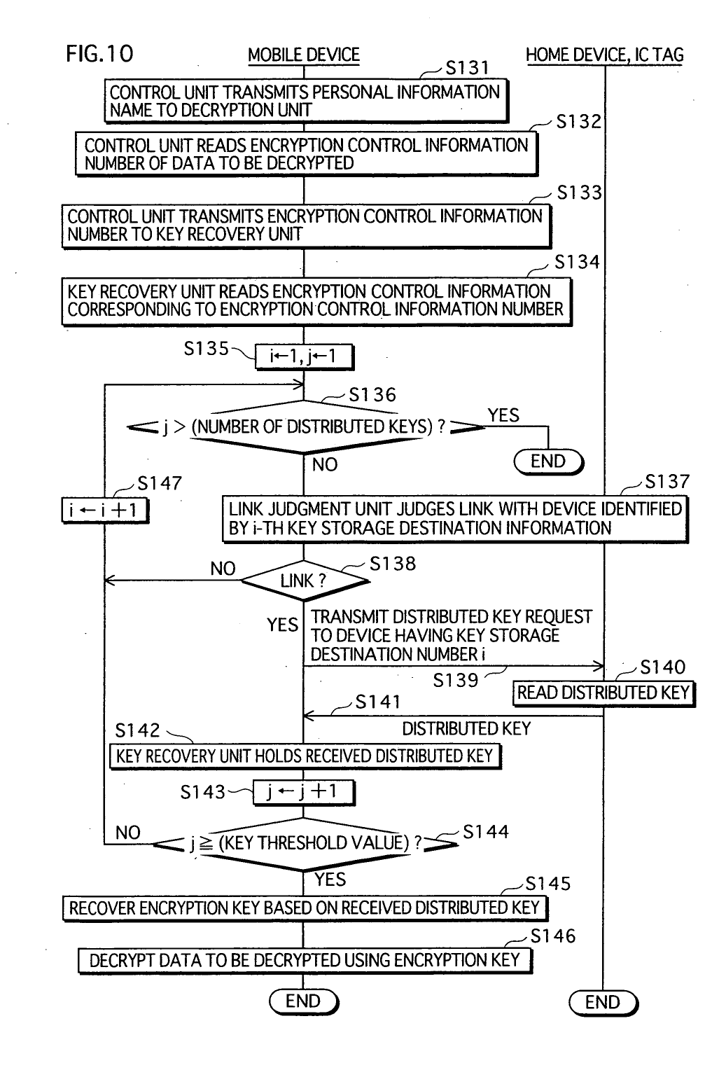

The decryption processing of the encrypted personal information will be described with reference to FIG. 10.

The user of the mobile device 20 inputs a personal information name of personal information the user wants to view, using the key included in the user input acquisition unit 215.

The user input acquisition unit 215 transmits the inputted personal information name to the control unit 216.

The control unit 216 receives the personal information name from the user input acquisition unit 215.

The control unit 216 transmits the personal information name to the decryption unit 208 (Step S131).

The control unit 216 reads a personal information file including the personal information name of encrypted data needed to be decrypted from the personal information storage unit 201, and extracts an encryption control information number included in the personal information file (Step S132).

The control unit 216 transmits the extracted encryption control information number to the key recovery unit 207 (Step S133).

The key recovery unit 207 receives the encryption control information number, and reads encryption control information including the encryption control information number from the encryption control information storage unit 214 (Step S134).

The key recovery unit 207 initializes internal counter values i and j with a value “1”, respectively (Step S135).

The key recovery unit 207 judges whether the value i is greater than the number of distributed keys (Step S136).

When the value i is greater than the number of distributed keys (Step S136: YES), the processing terminates.

When the value i is no more than the number of distributed keys (Step S136: NO), the key recovery unit 207 transmits a link judgment instruction including a key distribution type and i-th key storage destination information that are included in the encryption control information, to the link judgment unit 210.

The link judgment unit 210 attempts to establish a link with a device identified by the i-th key storage destination information, as described above (Step S137).

When the link is not established (Step S138: NO), the processing moves to Step S147 described later.

When the link is established (Step S138: YES), the key recovery unit 207 transmits a distributed key reading instruction including the i-th key storage destination information and the key identification information included in the encryption control information, to a communication unit corresponding to the key distribution type included in the encryption control information.

Here, when the key distribution type has a value “1”, the communication unit is the transmission/reception unit 206, which transmits the distributed key reading instruction including the key identification information to the device shown by the i-th key storage destination information (Step S139).

Also, when the key distribution type has a value “2”, the communication unit is the IC tag communication unit 212, which attempts to read the key identification information and the distributed key from an IC tag identified by the key storage destination information.

The device identified by the key storage destination information reads a distributed key corresponding to the received key identification information stored on a distributed key storage unit (Step S140).

The device transmits the read distributed key to the mobile device 20 (Step S141).

The communication unit receives the distributed key, and transmits the received distributed key to the key recovery unit 207.

The key recovery unit 207 receives the distributed key and holds the distributed key (Step S142).

The key recovery unit 207 increments the internal counter value j by one (Step S143).

The key recovery unit 207 judges whether the internal counter value j is no less than the key threshold value included in the encryption control information (Step S144).

When the value j is less than the key threshold value (Step S144: NO), the key recovery unit 207 increments the internal counter value i by one (Step S147), and the processing moves to Step S136.

When the value j is no less than the key threshold value (Step S144: YES), the key recovery unit 207 recovers a decryption key using the received distributed key (Step S145).

The key recovery unit 207 transmits the recovered decryption key to the decryption unit 208.

The decryption unit 208 receives the decryption key, and reads the personal information file corresponding to the personal information name from the personal information storage unit 201.

The decryption unit 208 decrypts encrypted personal information included in the personal information file using the decryption key (Step S146), and transmits decrypted personal information to the display unit 217.

The display unit 217 receives and displays the personal information, and displays the personal information.

Also, the key recovery unit 207 and the link judgment unit 210 repeat the above-described Steps S134 to S144. When the number of established links reaches less than (the key threshold value-1), the key recovery unit 207 and the link judgment unit 210 delete the decryption key from the decryption unit 208, delete the decrypted personal information from the decryption unit 208 and the display unit 217, and stop displaying the personal information on the display unit 217.

### MODIFICATION EXAMPLES

While the present invention has been described based on the above embodiment, the present invention is not limited to the above embodiment. The present invention also includes the following cases.

(1) In the above embodiment, the mobile device 20 generates a distributed key relating to an encryption key, and recovers a decryption key (identical with the encryption key) using the distributed key. However, one device may generate a distributed key relating to an encryption key, and another device may recover a decryption key using the distributed key.

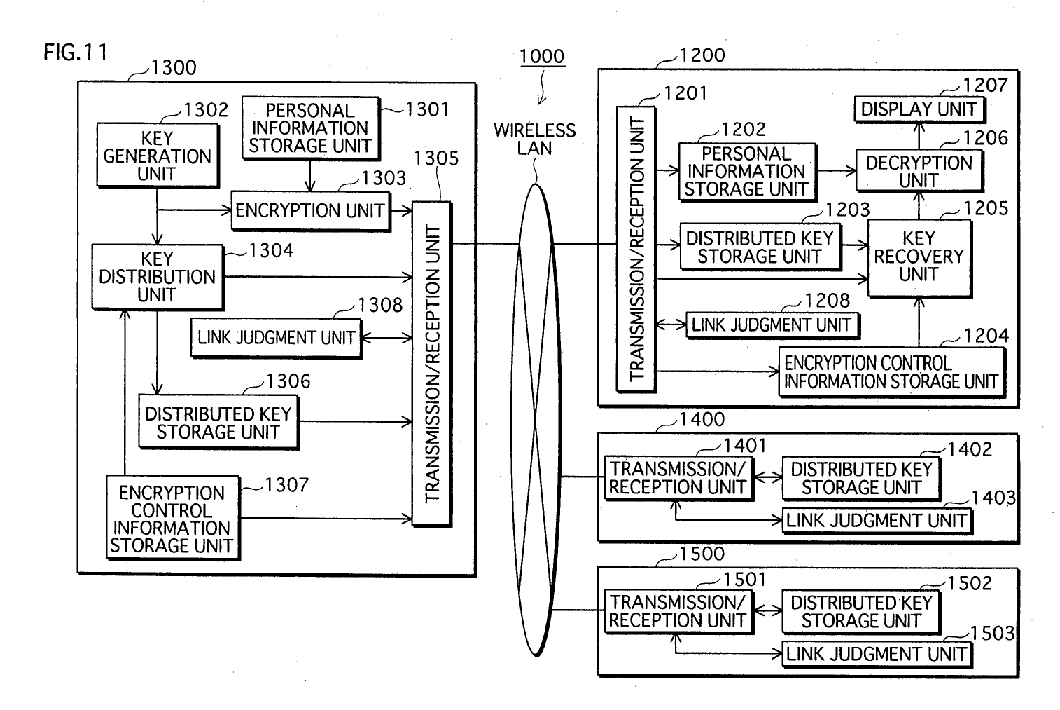

A personal information management system 1000 is composed of a home device 1300, a mobile device 1200, a device 1400, and a device 1500, as shown in FIG. 11.

The home device 1300 is disposed inside a home of a user of the mobile device 1200, and can communicate with only a device disposed inside the home, via a wireless LAN whose access range is restricted to inside the home.

The home device 1300 stores content that is secret information, and is composed of a personal information storage unit 1301, a key generation unit 1302, an encryption unit 1303, a key distribution unit 1304, a transmission/reception unit 1305, a distributed key storage unit 1306, an encryption control information storage unit 1307, and a link judgment unit 1308.

The key generation unit 1302 generates an encryption key for encrypting the content, and transmits the generated encryption key to the encryption unit 1303 and the key distribution unit 1304.

The encryption unit 1303 generates encrypted content by encrypting the content using the encryption key, and transmits the encrypted content to the mobile device 1200 via the transmission/reception unit 1305.

The encryption control information storage unit 1307 stores encryption control information including the number of distributed keys distributed from the encryption key (for example, a value “4”), a key threshold value (for example, a value “3”), and as a key storage destination identification, identification information of the home device 1300, identification information of the device 1400, and identification information of the device 1500.

In order to recover the encryption key from the number of distributed keys no less than the key threshold value, the key distribution unit 1304 generates a first to a fourth distributed keys by distributing the encryption key into four pieces based on the number of distributed keys stored on the encryption control information storage unit 1307, and stores the first distributed key on the distributed key storage unit 1306.

The mobile device 1200 reads the first distributed key stored on the distributed key storage unit 1306 via the transmission/reception unit 1305.

The key distribution unit 1304 transmits the second distributed key to the mobile device 1200, transmits the third distributed key to the device 1400, and transmits the fourth distributed key to the device 1500.

The key distribution unit 1304 reads the encryption control information from the encryption control information storage unit 1307, transmits the read encryption control information to the mobile device 1200 via the transmission/reception unit 1305, and deletes the encryption control information from the encryption control information storage unit 1307.

Before transmission and reception of data, the link judgment unit 1308 judges whether a link is established with a link judgment unit included in a device that is a communication opposite party.

The device 1400 is composed of a transmission/reception unit 1401, a distributed key storage unit 1402, and a link judgment unit 1403, as shown in FIG. 11.

The transmission/reception unit 1401 receives the third distributed key from the home device 1300, and stores the third distributed key on the distributed key storage unit 1402.

Also, the third distributed key stored on the distributed key storage unit 1402 is transmitted to the mobile device 1200 via the transmission/reception unit 1401.

Before transmission and reception of data, the link judgment unit 1403 judges whether a link is established with a link judgment unit included in a device that is a communication opposite party.

Similarly, the device 1500 is composed of a transmission/reception unit 1501, a distributed key storage unit 1502, and a link judgment unit 1503, as shown in FIG. 11.

The transmission/reception unit 1501 receives the fourth distributed key from the home device 1300, and stores the fourth distributed key on the distributed key storage unit 1502. The fourth distributed key stored on the distributed key storage unit 1502 is transmitted to the mobile device 1200 via the transmission/reception unit 1501.

Before transmission and reception of data, the link judgment unit 1503 judges whether a link is established with a link judgment unit included in a device that is a communication opposite party.

The mobile device 1200 is composed of a transmission/reception unit 1201, a personal information storage unit 1202, a distributed key storage unit 1203, an encryption control information storage unit 1204, a key recovery unit 1205, a decryption unit 1206, a display unit 1207, and a link judgment unit 1208.

The transmission/reception unit 1201 communicates with the home device 1300, the device 1400, and the device 1500.

Before transmission and reception of data with the home device 1300, the device 1400, and the device 1500, the link judgment unit 1208 judges whether a link is established with each link judgment unit included in devices that are communication opposite parties, respectively.

The personal information storage unit 1202 stores the encrypted content received from the home device 1300 via the transmission/reception unit 1201.

The distributed key storage unit 1203 stores the second distributed key received from the home device 1300 via the transmission/reception unit 1201.

The encryption control information storage unit 1204 stores the encryption control information received from the home device 1300 via the transmission/reception unit 1201.

The key recovery unit 1205 reads the encryption control information from the encryption control information storage unit 1204, and instructs the link judgment unit 1208 to judge whether a link is established with each device identified by each of pieces of the identification information of the home device 1300, the identification information of the device 1400, and the identification information of the device 1500, which are the key storage destination identifications included in the read encryption control information.

The key recovery unit 1205 attempts to acquire a distributed key from a device whose link is established with the mobile device 1200 among the home device 1300, the device 1400, and the device 1500, via the transmission/reception unit 1201. When three or more of the distributed keys respectively held in the home device 1300, the device 1400, the device 1500, and the mobile device 1200, can be acquired, the key recovery unit 1205 recovers a decryption key (identical with the encryption key) using three among the acquired distributed keys, and transmits the decryption key to the decryption unit 1206.

The decryption unit 1206 reads the encrypted content from the personal information storage unit 1202, and generates the content by decrypting the encrypted content using the decryption key.

The decryption unit 1206 transmits the content to the display unit 1207, and the display unit 1207 displays the received content on its display.

Also, the key recovery unit 1205 periodically attempts to acquire the first, the third, and the fourth distributed keys, as described above. When three or more of the four distributed keys including the second distributed key cannot be acquired, the key recovery unit 1205 deletes the decryption key held in the decryption unit 1206, deletes the content held in the decryption unit 1206 and the display unit 1207, and stops displaying the content on the display unit 1207.

According to the above, when the mobile device 1200 can communicate with the home device 1300, and when the home device 1300 can communicate with at least one of the device 1400 and the device 1500, the mobile device 1200 can acquire three or more distributed keys, recover the decryption key from the acquired distributed keys, and decrypt the encrypted content using the decryption key. This allows the user of the mobile device 1200 to view the content only inside the home.

(2) In the above modification example (1), the home device 1300 that generates the distributed keys holds one of the generated distributed keys. However, a device that generates a distributed key may not have the distributed key.

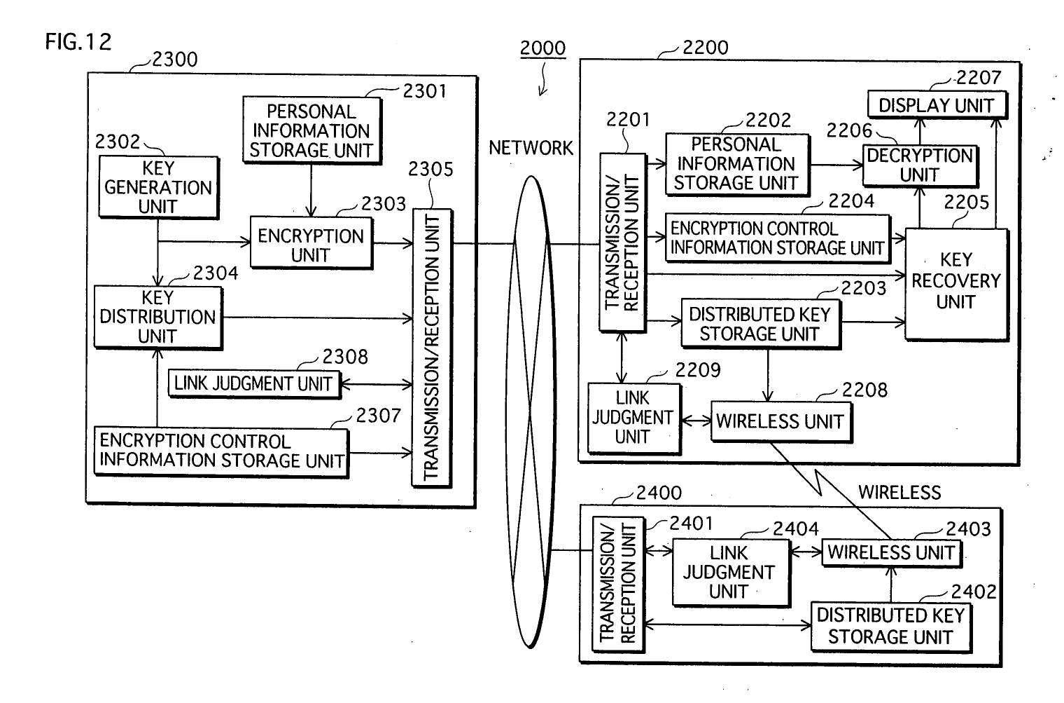

A personal information management system 2000 is composed of a premium content transmission device 2300 disposed in a ticket center for selling a concert ticket, a mobile device 2200 held by a user who purchases the concert ticket, and a gate device 2400 disposed in a concert hall, as shown in FIG. 12. The personal information management system 2000 allows the purchaser of the ticket to view premium content only inside the concert hall, the premium content being special content generally unavailable.

The gate device 2400 communicates with the mobile device 2200 via a wireless whose access range set as inside the concert hall. Thereby, only when the mobile device 2200 is inside the concert hall, the gate device 2400 can communicate with the mobile device 2200.

The premium content transmission device 2300 is composed of a personal information storage unit 2301 storing the premium content, a key generation unit 2302, an encryption unit 2303, a key distribution unit 2304, a transmission/reception unit 2305, an encryption control information storage unit 2307, and a link judgment unit 2308.

The key generation unit 2302 generates an encryption key for encrypting the premium content, and transmits the generated encryption key to the encryption unit 2303 and the key distribution unit 2304.

The encryption unit 2303 generates encrypted premium content by encrypting the premium content using the encryption key, and transmits the encrypted premium content to the mobile device 2200 via the transmission/reception unit 2305.

The encryption control information storage unit 2307 stores encryption control information including the number of distributed keys distributed from the encryption key (for example, a value “2”), a key threshold value (for example, a value “2”), and identification information of the gate device 2400 as a key storage destination identification.

In order to recover the encryption key from the number of distributed keys no less than the key threshold value, the key distribution unit 2304 generates a first and a second distributed keys by distributing the encryption key into two pieces based on the number of distributed keys stored on the encryption control information storage unit 2307, and transmits the first distributed key to the mobile device 2200, and transmits the second distributed key to the gate device 2400.

The key distribution unit 2304 reads the encryption control information from the encryption control information storage unit 2307, transmits the read encryption control information to the mobile device 2220 via the transmission/reception unit 2305, and deletes the encryption control information from the encryption control information storage unit 2307.

Before transmission and reception of data, the link judgment unit 2308 judges whether a link is established with a link judgment unit included in a device that is a communication opposite party.

The gate device 2400 is composed of a transmission/reception unit 2401, a distributed key storage unit 2402, a wireless unit 2403, and a link judgment unit 2404, as shown in FIG. 12.

The transmission/reception unit 2401 receives the second distributed key from the premium content transmission device 2300, and stores the received second distributed key on the distributed key storage unit 2402.

The wireless unit 2403 communicates with the mobile device 2200 via the wireless.

Also, the mobile device 2200 reads the second distributed key stored on the distributed key storage unit 2402 via the wireless unit 2403.

Before transmission and reception of data, the link judgment unit 2404 judges whether a link is established with a link judgment unit included in a device that is a communication opposite party.

The mobile device 2200 is composed of a transmission/reception unit 2201, a personal information storage unit 2202, a distributed key storage unit 2203, an encryption control information storage unit 2204, a key recovery unit 2205, a decryption unit 2206, a display unit 2207, a wireless unit 2208, and a link judgment unit 2209.

The personal information storage unit 2202 stores the encrypted premium content received from the premium content transmission device 2300 via the transmission/reception unit 2201.

The distributed key storage unit 2203 stores the first distributed key received from the premium content transmission device 2300 via the transmission/reception unit 2201.

The encryption control information storage unit 2204 stores the encryption control information received from the premium content transmission device 2300 via the transmission/reception unit 2201.

The wireless unit 2208 communicates with the gate device 2400 via the wireless.

The key recovery unit 2205 reads the encryption control information from the encryption control information storage unit 2204, communicates with the gate device 2400 identified by the key storage destination identification included in the read encryption control information via the wireless unit 2208, and attempts to acquire the second distributed key that is a distributed key stored on the gate device 2400.

When the second distributed key held in the gate device 2400 can be acquired, the key recovery unit 2205 recovers a decryption key (identical with the encryption key) using the second distributed key and the first distributed key stored on the distributed key storage unit 2203, and transmits the decryption key to the decryption unit 2206.

The decryption unit 2206 reads the encrypted premium content from the personal information storage unit 2202, and generates the premium content by decrypting the encrypted premium content using the decryption key.

The decryption unit 2206 transmits the premium content to the display unit 2207, and the display unit 2207 displays the received premium content on its display.

Also, the key recovery unit 2205 periodically attempts to read the second distributed key held in the distributed key storage unit 2402 of the gate device 2400 via the wireless unit 2208. When the second distributed key cannot be read, the key recovery unit 2205 deletes the decryption key held in the decryption unit 2206, and deletes the premium content held in the decryption unit 2206 and the display unit 2207.

According to the above, only when the mobile device 2200 can perform wireless communication with the gate device 2400, and only inside the concert hall where the mobile device 2200 can acquire the second distributed key from the gate device 2400, the mobile device 2200 can recover the decryption key using the first and the second distributed keys, and can decrypt the encrypted premium content using the decryption key. This allows the user of the mobile device 2200 to view the premium content only inside the concert hall. When going out of the concert hall, the user cannot view the premium content.

(3) In the above embodiment, the description has been provided using the example that the personal information acquisition unit 213 is the digital camera. However, the present invention is not limited to this example, so long as the personal information acquisition unit 213 can acquire personal information.

For example, the personal information acquisition unit 213 may include a function of connecting a network, acquire video and audio from a distribution server for distributing the video, the audio, and the like via the network, and store the video and the audio in the personal information storage unit 201.

Also, the personal information acquisition unit 213 may include a TV tuner, receive a broadcast wave broadcasted by a broadcast device using the TV tuner, modulate the received broadcast wave, perform a signal processing on the modulated broadcast wave, to acquire a video signal and the like, digitalize the acquired video signal and the like, and stores the digitalized video signal and the like on the personal information storage unit 201.

Also, the personal information is not limited to the image photographed using the digital camera as described above. The personal information includes the following: information inputted to the mobile device 20 by the user including innate information such as a name, a birth date, and biometric information, and acquired information such as a handle name, an address, and an occupation; and history information such as a purchase history, a communication history, a clinical history/medication history. Furthermore, the personal information is not limited to the above information, and may include a copyright work such as a personally purchased movie work whose use is restricted to inside a home.

Also, in the above embodiment, only the personal information has been treated. However, without limiting to the personal information, commercial information may be treated in the same way with the personal information.

Only when use of the commercial information is restricted to only inside the home, the commercial information can be used.

(4) A method of distributing a key by the key distribution unit is not limited to the above-described method.

For example, a method of expressing a secret key by a sum of M distributed keys may be used. According to this method, the secret key can be given only after collecting all the M distributed keys.

(5) A method of judging whether a link is established is not limited to the above-described method.

For example, a link may be judged to be established by access of ad hoc wireless communication like a PAN (Personal Area Network).

Also, for example, in order to detect that the mobile device 20 is inside the home, a protocol such as broadcast and UPnP (Universal Plug and Play) may be used for detecting that the mobile device 20 belongs to a same subnetwork as the home device 30.

For example, the mobile device 20 acquires an IP (Internet Protocol) address of the home device 30, and judges whether the acquired IP address has a same subnet address as that of an IP address of the mobile device 20. When the acquired IP address has the same subnet address, the link is judged to be established. This allows the mobile device 20 to detect that the mobile device 20 is inside the home where the home device 30 is disposed.

The mobile device 20 may acquire the IP address of the home device 30, directly from the home device 30, or from a device other than the home device 30, such as a DNS (Domain Name System) server.

Also, the mobile device 20 may be detected to be inside the home where the home device 30 is disposed, by access of ad hoc wireless communication having a restricted electric wave access distance, or by judging that a time period from transmission to return of a PING (Packet InterNet Groper) between the home device 30 and the mobile device 20 is within a predetermined time period, for example, one second.

(6) In the above embodiment, a piece of personal information has been identified by a corresponding personal information name. However, a method of identifying personal information is not limited to this.

For example, a piece of personal information may be identified using mutually different numbers allocated to each piece of the personal information.

Also, when specifying personal information desired for encryption and decryption, the user inputs a corresponding personal information name using the key included in the user input acquisition unit 215. However, the user may input an identification number as described above. Also, the user may display pieces of candidate personal information for decryption on the display unit 217, and select one among pieces of the candidate personal information.

(7) In the above embodiment, when all devices to hold a distributed key are collected, the mobile device 20 encrypts acquired personal information. However, a timing of encrypting personal information is not limited to this.

For example, the following may be employed in the mobile device 20. Immediately after the personal information acquisition unit 213 acquires personal information, the key generation unit 202 generates an encryption key, the encryption unit 203 encrypts the personal information using the encryption key, and the personal information storage unit 201 stores the encrypted personal information.

And then, when the link judgment unit 210 judges that a link is established with all the devices to hold a distributed key, the key distribution unit 204 generates a plurality of distributed keys from the encryption key, the distributed key storage unit 205 stores one of the plurality of distributed keys, and transmits other distributed keys to all the devices to hold a distributed key.

Also, in the above embodiment, when the user wants to view encrypted personal information, the mobile device 20 decrypts the encrypted personal information. However, a timing of decrypting encrypted personal information is not limited to this.

For example, the following may be employed in the mobile device 20. When the link judgment unit 210 judges that a link is established with the link judgment unit 303 of the home device 30, the decryption unit 208 decrypts encrypted personal information corresponding to encryption control information having a value “1” stored on the personal information storage unit 201, using a decryption key. When the link judgment unit 210 judges that the link is not established, the encryption unit 203 encrypts the personal information using an encryption key that is a key identical with the decryption key, and the key deletion control unit 209 deletes the encryption key and the decryption key.

This allows personal information to be automatically encrypted when the user carries the mobile device 20 out of the home, whereas the personal information is stored in plaintext inside the home.

Also, the personal information may be decrypted when used, while being encrypted even inside the home. In this case, the personal information may be encrypted every time updated, or every predetermined time period.

(8) When the user stores personal information on the mobile device 20, or when the user carries the mobile device 20 out of the home, the mobile device 20 may encrypt the personal information, and may store a distributed key generated from an encryption key used for the encryption on the home device 30. Also, when the mobile device 20 is inside the home, the personal information may be encrypted with a trigger of an instruction from the user.

(9) The mobile device 20 needs not to store the distributed keys generated from the encryption key relating to the personal information on the IC tags 40, 50, and 60 immediately after the personal information acquisition unit 213 acquires the personal information.

For example, the mobile device 20 may include an authentication information holding unit operable to pre-hold authentication information relating to the user such as passwords and biometric information, an authentication information receiving unit operable to receive an input of the authentication information by the user, and an authenticating unit operable to perform authentication using the authentication information. When the user of the mobile device 20 inputs the authentication information, the authenticating unit compares the inputted authentication information with the authentication information held in the authentication information holding unit. When the above two pieces of authentication information corresponds with each other, or an error between the two pieces of authentication information is within a predetermined range, the mobile device 20 may judge that the user authentication succeeds, and store the distributed keys on the IC tags 40, 50, and 60, respectively.

Also, the following may be employed. The user inputs a password to the authentication information receiving unit. When the user authentication succeeds, the mobile device 20 encrypts the personal information using the encryption key, distributes the encryption key, and stores the distributed key on an IC tag and the like attached to a belonging the user carries, respectively.

Furthermore, the following may be employed. A trigger signal is sent from a front door of the home. Immediately before the user carrying the mobile device 20 passes through the front door, the mobile device 20 may store the distributed keys on each of the IC tags attached to each of belongings the user carries.

(10) Furthermore, in the secret sharing, the number of distributed keys distributed from a decryption key and a key threshold value for recovering secrets are not limited to the values used in the embodiment. An appropriate value may be selected depending on systems.

For example, when using four home devices 30, the number of distributed keys is set as “5”. The mobile device 20 distributes a secret key into five distributed keys, stores thereon one, and stores other four distributed keys on each of the four home devices 30. With a key threshold value set as “2”, when at least one of the four home devices 30 is power-on, the mobile device 20 acquires a distributed key from any of the home devices 30 being power-on, and recovers a decryption key using the distributed key stored on the mobile device 20 and the acquired distributed key, thereby decrypting encrypted personal information using the decryption key.

(11) In the above embodiment, the description has been provided using the example that the encryption control information stored on the encryption control information storage unit 214 includes one key distribution type. However, encryption control information is not limited to this.

For example, encryption control information includes a key distribution type written as “1*2” showing a combination (AND) of a key distribution type having a value “1” and a key distribution type having a value “2”, and two pieces of key storage destination information each corresponding to the two key distribution types. The mobile device 20 may acquire a distributed key from each of a device corresponding to the key distribution type having a value “1” and a device corresponding to the key distribution type having a value “2”.

In this case, for example, with a key threshold value set as “3”, when the mobile device 20 can acquire both of the distributed key held in the home device 30 and the distributed key held in the IC tag 40 attached to the glasses, the mobile device 20 can recover a decryption key from three distributed keys including the distributed key held in the mobile device 20.

Also, encryption control information may include a plurality of key distribution types.

For example, the encryption control information may include two key distribution types: a key distribution type having a value “1” and a key distribution type having a value “2”, and two pieces of key storage destination information each corresponding to the two key distribution types.

According to this, with a key threshold value set as “2”, when the mobile device 20 can acquire either of the distributed key held in the home device 30 and the distributed key held in the IC tag 40 attached to the glasses, the mobile device 20 can recover a decryption key using the acquired distributed key and the distributed key held in the mobile device 20.

(12) In the above embodiment, the description has been provided using the example of attaching the IC tags 40, 50, and 60 to the glasses, the coat, and the watch, respectively. However, without limiting to this, an IC tag may be attached to any belonging of the user of the mobile device 20.

Also, instead of using IC tags, a belonging such as a contactless interface card and a mobile phone may be used.

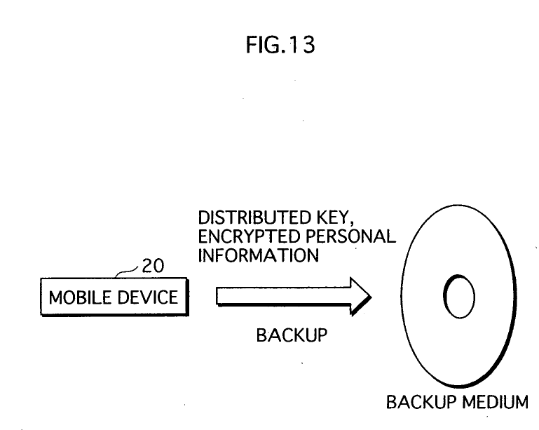

(13) The mobile device 20 may store encrypted personal information stored on the personal information storage unit 201 and a distributed key stored on the distributed key storage unit 205, on a backup medium such as a DVD-RAM, as shown in FIG. 13.

According to this, even when the user of the mobile device 20 purchases a new mobile device 20, the encrypted personal information and the distributed key can be restored by storing the encrypted personal information stored on the backup medium on a personal information storage unit 201 of the new mobile device 20, and storing the distributed key stored on the backup medium on a distributed key storage unit 205 of the new mobile device 20.

Here, even when the user loses the backup medium, the encrypted personal information is not unauthorizedly viewed because being encrypted.

(14) A device to store a distributed key may be determined depending on kinds of the personal information, whether a device disposed in a specified position such as the home device 30, or a device related to a specified person such as the IC tags 40, 50, and 60.

For example, a family photograph taken using a digital camera is related to a specified home device 30 disposed inside the home, and can be seen only inside the home. Also, a photograph taken a friend is related to a specified belonging of a photographer of the photograph, and only the photographer himself can see the photograph.

These are based on rule information belonging to personal information and determining to what relates. According to this rule information, a distributed key is generated and stored on each device. Also, the personal information is decrypted by receiving the decryption key from each device. In a case of information relating to a digital camera, for example, its rule may be determined depending on a photographer or a subject of a photograph taken using the digital camera. Also, in a case of a copyright work, a holder of the copyright work may determine its rule.

(15) When the number of distributed keys no less than the key threshold value can be acquired from a device such as an IC tag, the mobile device 20 may change a processing depending on the number of acquired distributed keys.

For example, suppose a key threshold value is set as “5”, eight distributed keys are generated from an encryption key, each of the distributed keys is stored on seven IC tags, and the mobile device 20 stores ten pieces of encrypted personal information on the personal information storage unit 201. When distributed key can be acquired from five of the seven IC tags, he mobile device 20 decrypts six pieces of the personal information stored on the personal information storage unit 201, allow to be viewed. When a distributed key can be acquired from the seven IC tags, the mobile device 20 decrypts all ten pieces of the personal information stored on the personal information storage unit 201, to allow to be viewed.

Also, for example, suppose a key threshold value is set as “5”, eight distributed keys are generated from an encryption key, each of the distributed keys is stored on seven IC tags, and the mobile device 20 stores, as personal information, an encrypted image and an encrypted address book on the personal information storage unit 201. When a distributed key can be acquired from five of the seven IC tags, the mobile device 20 decrypts the encrypted image stored on the personal information storage unit 201 to allow to be viewed. When a distributed key can be acquired from the seven IC tags, the mobile device 20 decrypts, in addition to the encrypted image, the encrypted address book stored on the personal information storage unit 201 to allow to be viewed.

(16) Each of the above devices is specifically a computer system composed of a microprocessor, a ROM, a RAM, a hard disk unit, a display unit, a keyboard, a mouse, and the like. A computer program is stored on the RAM or the hard disk unit.

Functions of each of the devices are achieved by the microprocessor operating in accordance with the computer program. Here, the computer program is composed of a plurality of command codes that show instructions to the computer, in order to achieve predetermined functions.

(17) All or part of compositional elements of each of the above devices may be composed of one system LSI (Large Scale Integration). The system LSI is a super-multifunctional LSI manufactured by integrating a plurality of compositional units on one chip, and is specifically a computer system composed of a microprocessor, a ROM, a RAM, and the like. A computer program is stored on the RAM. Functions of the system LSI are achieved by the microprocessor operating in accordance with the computer program. The system LSI may be manufactured by separately integrating the plurality of compositional units into one chip, or by integrating the plurality of compositional units into one chip including all or part of the functions. Here, the LSI may be called an IC, a system LSI, a super LSI, and an ultra LSI, depending on integration degree.

Also, a method of forming integrated circuits is not limited to LSIs, and may be realized using a dedicated circuit or a general-purpose processor. Furthermore, the following may be used: an FPGA (Field Programmable Gate Array) programmable after manufacturing LSIs; and a reconfigurable processor in which connection and setting of the circuit cell inside an LSI can be reconfigured.

Furthermore, when new technology for forming integrated circuits that replaces LSIs becomes available as a result of progress in semiconductor technology or semiconductor-derived technologies, functional blocks may be integrated using such technology. One possibility lies in adaptation of biotechnology.

(18) All or part of the compositional elements of each of the above devices may be composed of a removable IC card or a single module. The IC card or the single module is a computer system composed of a microprocessor, a ROM, a RAM, and the like. The IC card or the module may include the above-described super-multifunctional LSI. Functions of the IC card or the module are achieved by the microprocessor operating in accordance with the computer program. The IC card or the module may be tamper-resistant.

(19) The present invention may be the above methods. Also, the present invention may be a computer program that realizes the methods by a computer, or a digital signal composed of the computer program.

Furthermore, the present invention may be a computer-readable storage medium such as a flexible disk, a hard disk, a CD-ROM (Compact Disk Read Only Memory), an MO (Magneto-Optical), a DVD (Digital Versatile Disk), a DVD-ROM (Digital Versatile Disk Read Only Memory), a DVD-RAM (Digital Versatile Disk Random Access Memory), a BD (Blu-ray Disc), and a semiconductor memory, which stores the computer program or the digital signal. Furthermore, the present invention may be the computer program or the digital signal stored on the storage medium.

Furthermore, the present invention may be the computer program or the digital signal transmitted via an electric communication network, a wireless or wired communication network, a network such as Internet, data broadcasting, and the like.

Furthermore, the present invention may be a computer system that includes a microprocessor and a memory, the memory storing the computer program, and the microprocessor operating in accordance with the computer program.

Furthermore, the program or the digital signal may be executed by another independent computer system, by transferring the program or the digital signal to the recording medium, or by transferring the program or the digital signal via a network or the like.

(20) The present invention may be any combination of the above-described embodiment and modifications.

### INDUSTRIAL APPLICABILITY

The present invention can be manufactured and sold in an industry relating to systems and electrical devices such as mobile devices that manage confidential personal information.

1. A personal information management device that manages personal information, comprising:
an information storage unit storing the personal information in encrypted form;
a distributed key storage unit storing a first distributed key, where the first distributed key and a second distributed key are distributed from a decryption key based on a secret sharing scheme;
a link judgment unit operable to judge whether communication is possible with a distributed key storage device storing the second distributed key;
an acquisition unit operable to, when the communication is possible, acquire the second distributed key from the distributed key storage device;
a decryption key recovering unit operable to recover the decryption key using the first and the second distributed keys based on the secret sharing scheme; and
a decryption unit operable to decrypt the encrypted personal information using the recovered decryption key.

2. The personal information management device of claim 1, wherein
the link judgment unit includes:
a link request unit operable to transmit a link request to the distributed key storage device within a predetermined communication range;
a link response receiving unit operable to receive a response to the link request from the distributed key storage device; and
a determination unit operable to, when the response is received, determine that the communication is possible with the distributed key storage device.

3. The personal information management device of claim 1, wherein
the distributed key storage device is disposed in a specified position, and transmits a packet to the personal information management device within a predetermined communication range at a predetermined time interval, and
the link judgment unit includes:
a packet receiving unit operable to receive the packet; and
a determination unit operable to, when the packet is received, determine that the communication is possible with the distributed key storage device.

4. The personal information management device of claim 1, wherein
the distributed key storage device holds judgment information for the link judgment unit to judge whether the communication is possible, and
the link judgment unit includes:
a reading unit operable to read the judgment information held in the distributed key storage device within a predetermined communication range; and
a determination unit operable to, when the judgment information is read, determine that the communication is possible.

5. The personal information management device of claim 4, wherein
the distributed key storage device is an IC tag attached to a belonging of a user of the personal information management device, and
the reading unit reads the judgment information held in the IC tag within a wireless access range.

6. The personal information management device of claim 1, wherein
the link judgment unit includes:
an address storage unit storing an IP address of the personal information management device;
an address acquisition unit operable to acquire an IP address of the distributed key storage device;
an address judgment unit operable to judge whether the IP address of the personal information management device and the IP address of the distributed key storage device belong to a same subnetwork; and
a determination unit operable to, when the judgment is affirmative, determine that the communication is possible with the distributed key storage device.

7. The personal information management device of claim 1, wherein
the link judgment unit, after judging that the communication is possible with the distributed key storage device, further periodically judges whether the communication is possible, and
the personal information management device further comprises
a deletion unit operable to, when the communication is impossible, delete the decryption key recovered by the decryption key recovering unit and the personal information decrypted by the decryption unit.

8. The personal information management device of claim 1 further comprising:
a distributed key generation unit operable to distribute the decryption key into the first and the second distributed keys based on the secret sharing scheme, and delete the decryption key;
a distributed key transmission unit operable to transmit the second distributed key to the distributed key storage device; and
a writing unit operable to store the first distributed key on the distributed key storage unit.

9. The personal information management device of claim 1 further comprising:
a distributed key receiving unit operable to receive the first distributed key; and
a writing unit operable to store the received first distributed key on the distributed key storage unit.

10. The personal information management device of claim 1, wherein
the information storage unit further stores encrypted additional personal information,
the personal information management device further comprises:
an additional distributed key storage unit storing one of n additional distributed keys distributed from an additional decryption key based on a (k,n) threshold secret sharing scheme;
an additional link judgment unit operable to judge whether each communication is possible with (n-1) additional distributed key storage devices each storing any one of (n-1) additional distributed keys that are mutually different other than the one additional distributed key;
an additional acquisition unit operable to, when the communication is possible with no less than (k-1) additional distributed key storage devices, acquire an additional distributed key from each of the (k-1) additional distributed key storage devices;
an additional decryption key recovering unit operable to recover the additional decryption key using the (k-1) additional distributed keys and the one additional distributed key based on the (k,n) threshold secret sharing scheme; and
an additional decryption unit operable to decrypt the encrypted additional personal information using the recovered additional decryption key.

11. A distributed key storage device that manages a distributed key generated based on a secret sharing scheme, comprising:
a distributed key storage unit storing a first distributed key, where the first distributed key and a second distributed key are distributed from a decryption key used for decrypting encrypted personal information based on a secret sharing scheme;
a communication unit operable to communicate, such that a personal information management device storing the encrypted personal information judges whether communication is possible; and
a transmission unit operable to transmit the first distributed key to the personal information management device.

12. The distributed key storage device of claim 11, wherein
the communication unit includes:
a request receiving unit operable to receive a link request from the personal information management device; and
a response transmission unit operable to transmit a response to the link request.

13. The distributed key storage device of claim 11, being disposed in a specified position, wherein
the communication unit transmits a packet to the personal information management device within a predetermined communication range at a predetermined time interval.

14. The distributed key storage device of claim 11, holding judgment information for the communication unit to judge whether the communication is possible, wherein
the communication unit transmits the judgment information to the personal information management device within a predetermined communication range.

15. The distributed key storage device of claim 14, being an IC tag attached to a belonging of a user of the personal information management device, wherein
the communication unit transmits the judgment information to the personal information management device within a wireless access range.

16. A personal information management system including a personal information management device that manages personal information and a distributed key storage device, the distributed key storage device comprising:
a first distributed key storage unit storing a first distributed key, where the first distributed key and a second distributed key are distributed from a decryption key based on a secret sharing scheme;
a first link judgment unit operable to judge whether communication is possible with the personal information management device; and
a transmission unit operable to, when the communication is possible with the personal information management device, transfer the first distributed key to the personal information management device,
the personal information management device comprising:
a information storage unit storing the encrypted personal information;
a second distributed key storage unit storing the second distributed key;
a second link judgment unit operable to judge whether communication is possible with the distributed key storage device;
an acquisition unit operable to, when the communication is possible with the distributed key storage device, acquire the first distributed key from the distributed key storage device;
a decryption key recovering unit operable to recover the decryption key using the first and the second distributed keys based on the secret sharing scheme; and
a decryption unit operable to decrypt the encrypted personal information using the recovered decryption key.

17. A personal information management method used in a personal information management device storing encrypted personal information and a first distributed key, where the first distributed key and a second distributed key are distributed from a decryption key based on a secret sharing scheme, the personal information management method comprising steps of:
judging a link whether communication is possible with a distributed key storage device storing the second distributed key;
acquiring, when the communication is possible, the second distributed key from the distributed key storage unit;
recovering the decryption key using the first and the second distributed keys based on the secret sharing scheme; and
decrypting the encrypted personal information using the recovered decryption key.

18. A computer program used in a personal information management device storing encrypted personal information and a first distributed key, where the first distributed key and a second distributed key are distributed from a decryption key based on a secret sharing scheme, the computer program comprising steps of:
judging a link whether communication is possible with a distributed key storage device storing the second distributed key;
acquiring, when the communication is possible, the second distributed key from the distributed key storage unit;
recovering the decryption key using the first and the second distributed keys based on the secret sharing scheme; and
decrypting the encrypted personal information using the recovered decryption key.

19. A storage medium storing the computer program of claim 18.

20. An integrated circuit that manages personal information, comprising:
an information storage unit storing the personal information in encrypted form;
a distributed key storage unit storing a first distributed key, where the first distributed key and a second distributed key are distributed from a decryption key based on a secret sharing scheme;
a link judgment unit operable to judge whether communication is possible with a distributed key storage device storing the second distributed key;
an acquisition unit operable to, when the communication is possible, acquire the second distributed key from the distributed key storage device;
a decryption key recovering unit operable to recover the decryption key using the first and the second distributed keys based on the secret sharing scheme; and
a decryption unit operable to decrypt the encrypted personal information using the recovered decryption key.
